(19) United States
(12) Patent Application Publication
(10) Pub. No.: US 2021/0383322 A1
(43) Pub. Date: Dec. 9, 2021

(54) COMPUTERIZED APPLICATIONS FOR COORDINATING DELIVERY DATA WITH MOBILE COMPUTING DEVICES

(71) Applicant: PUT CORP., Burlington, MA (US)

(72) Inventors: Bruce Williams, Phoenix, AZ (US); Andrus Nomm, Izmir (TR); Alex Greg Mardikian, Scottsdale, AZ (US)

(21) Appl. No.: 17/359,235

(22) Filed: Jun. 25, 2021

Related U.S. Application Data
(63) Continuation-in-part of application No. 16/120,077, filed on Aug. 31, 2018.
(60) Provisional application No. 63/044,225, filed on Jun. 25, 2020.
(60) Provisional application No. 62/553,718, filed on Sep. 1, 2017.
(60) Provisional application No. 62/645,663, filed on Mar. 20, 2018.

(51) Int. Cl. G06Q 10/08; G06T 7/00; G06K 9/00

(52) U.S. Cl. CPC G06Q 10/0836; G06Q 10/0837; G06Q 10/0833; G06T 2207/30176; G06T 7/0004; G06K 9/00463; G06Q 10/087

(57) ABSTRACT

Systems and methods of managing the collection and delivery of goods using mobile computing devices includes a management system hosted on a server receiving a request from a first user through an application on a computing device for a pick-up of an item from a first location. A second user capable of fulfilling the pick-up request is identified. Details of the pick-up request are transmitted to an application on a second user computing device, wherein a visual map of the first location is displayed on the user computing device. Weight and/or dimensions of the item is uploaded to the application of the second user computing device. Delivery of the item to a second location is validated through at least one code identifier, wherein the code identifier is transmitted from the management system to the first user computing device.

### CROSS REFERENCE TO RELATED APPLICATION

This application claims priority to U.S. Provisional Application Ser. No. 63/044,225 entitled, “Computerized Applications for Coordinating Delivery Data with Mobile Computing Devices” filed Jun. 25, 2020 and is a continuation-in-part application of U.S. patent application Ser. No. 16/120,077 entitled, “Computerized Applications for Coordinating Delivery Data with Mobile Computing Devices” filed Aug. 31, 2018, which claims priority to U.S. Provisional Application Ser. No. 62/553,718 entitled, “System and Related Methods for Refuse Collection Management” filed Sep. 1, 2017 and U.S. Provisional Application Ser. No. 62/645,663 entitled, “System and Related Methods for Refuse Collection Management” filed Mar. 20, 2018, the entire disclosures of which is incorporated herein by reference.

### FIELD OF THE DISCLOSURE

The present disclosure is generally related to computerized applications for coordinating delivery data with mobile computing devices.

### BACKGROUND OF THE DISCLOSURE

The need for the collection and/or delivery of goods, materials, and refuse is ever increasing in today's consumer-driven society. In particular, the need for the disposal of unwanted items, such as trash and garbage (generally referred to herein as ‘refuse’) is continually increasing with the growing construction of new buildings and the renovation of existing structures. Customarily, construction debris, demolition debris, and unwanted building materials are disposed of using large dumpsters. These dumpsters are placed at the construction site and over the course of the construction project, workers put these refuse materials in the dumpster. When the dumpster is full, a waste collection company picks up the dumpster and disposes of the contents. Variations on this system include the use of smaller dumpsters or fabric-based refuse collection containers which can be purchased at a store, filled with refuse at a construction site, and removed by a disposal company. While these dumpsters are useful in many large-scale construction projects, smaller projects are often too small to make the use of a large dumpster economically justifiable, since getting a dumpster often costs in excess of $300. Similarly, homeowners handling do-it-yourself (DIY) projects cannot justify the costs of a dumpster relative to the scale of smaller projects.

To avoid the expense, demolition and construction refuse at smaller construction sites is often bagged in plastic trash bags which are then driven to a landfill by the homeowner or by a site worker, such as an employee of a construction company or builder. However, the time it takes for the site workers to dispose of the bagged refuse can be inefficient and negatively affect the bottom line of the project. Furthermore, for construction projects that a homeowner handles themselves, the homeowner may not be knowledgeable about how or where to dispose of certain refuse, nor may they have a suitable vehicle for transporting the refuse to a disposal site. DIYers may be forced to rent a vehicle to dispose of refuse, the costs of which, while typically less than renting a dumpster, can still be high. Moreover, in any situation where refuse needs to be disposed of, the disposing party often needs to wait until someone can pick up the refuse which means the refuse may need to sit curbside until it is picked up. This can cause unsightly appearances to the neighborhood and can create hazardous situations where potentially dangerous refuse is left accessible to children or animals in the neighborhood.

A similar situation occurs with some homeowners and DIYers who have difficulty getting building materials and supplies from stores to their home. Unless the homeowner owns a vehicle capable of carrying larger or heavy building materials, such as lumber, the homeowner must rely on someone with a vehicle capable of carrying the materials. In some cases, the homeowner may be able to rent a vehicle to carry the goods, but the costs of the rental can easily exceed $50 for just 1 hour of use of the vehicle. For a homeowner wanting to tackle a project at his or her home, one of the biggest hurdles he or she may face is the logistics of simply getting the building materials to their home.

Thus, a heretofore unaddressed need exists in the industry to address the aforementioned deficiencies and inadequacies.

### SUMMARY OF THE DISCLOSURE

Embodiments of the present disclosure provide a system for managing the collection and delivery of goods using mobile computing devices. Briefly described, in architecture, one embodiment of the system, among others, can be implemented as follows. Systems and methods of managing the collection and delivery of goods using mobile computing devices included a management system hosted on a server receiving a request from a first user through an application on a computing device for a pick-up of an item from a first location. A second user capable of fulfilling the pick-up request is identified. Details of the pick-up request are transmitted to an application on a second user computing device, wherein a visual map of the first location is displayed on the user computing device. Weight and/or dimensions of the item is uploaded to the application of the second user computing device. Delivery of the item to a second location is validated through at least one code identifier, wherein the code identifier is transmitted from the management system to the first user computing device.

The present disclosure can also be viewed as providing methods of managing the collection and delivery of refuse goods using mobile computing devices. In this regard, one embodiment of such a method, among others, can be broadly summarized by the following steps: receiving, on a collection and delivery management system hosted on a centralized server, a request from a first user through an application on a first user computing device for a pick-up of at least one refuse item from a first location; identifying at least one second user of the collection and delivery management system capable of fulfilling the pick-up request, wherein the at least one second user is identified from a group of possible second users having a vehicle sized to carry the at least one refuse item; transmitting details of the pick-up request to an application on a second user computing device of the identified at least one second user, wherein a visual map of the first location is displayed on a user interface of the second user computing device; uploading information about the at least one refuse item from the first user to the application of the second user computing device, wherein the information includes at least one of: a weight of the at least one refuse item, a dimension of the at least one refuse item, a material of the at least one refuse item, a condition of the at least one refuse item, or a state of the at least one refuse item; delivering, by the second user, the at least one refuse item to a second location, the second location being a way station, having facilities for disposal of the at least one refuse item, wherein way station is selected from a database of possible way stations, wherein selection of the way station from the database of possible way stations is determined based on at least one material accepted by the way station, wherein the at least one refuse item is within the at least one material accepted; and upon delivery of the at least one refuse item from the first location to the way station by the at least one second user, validating delivery of the at least one refuse item by the first user computing device through at least one code identifier, wherein the at least one code identifier is transmitted from the collection and delivery management system to the first user computing device.

The present disclosure can also be viewed as providing a system of managing the collection and delivery of goods using mobile computing devices. Briefly described, in architecture, one embodiment of the system, among others, can be implemented as follows. A collection and delivery management system is hosted on a centralized server, wherein a request is received from a first user through an application on a first user computing device for a pick-up of at least one item from a first location. At least one second user of the collection and delivery management system is identified as being capable of fulfilling the pick-up request. An application is running on a second user computing device, wherein details of the pick-up request are transmitted to the application of the identified at least one second user, wherein a visual map of the first location is displayed on a user interface of the second user computing device, wherein information about the at least one item is uploaded from the first user to the application of the second user computing device, wherein the information includes weight and/or dimensions of the at least one item. At least one validation code identifier is provided, wherein upon delivery of the at least one item from the first location to a second location by the at least one second user, delivery of the at least one item is validated by the first user computing device through the at least one code identifier, wherein the at least one code identifier is transmitted from the collection and delivery management system to the first user computing device.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram describing a platform of the collection and delivery management system, in accordance with a first exemplary embodiment of the present disclosure.

FIG. 2 is a diagram describing a public domain block of the platform of the collection and delivery management system, in accordance with the first exemplary embodiment of the present disclosure.

FIG. 3 is a diagram describing domain components of the platform of the collection and delivery management system, in accordance with the first exemplary embodiment of the present disclosure.

FIG. 4 is a diagram describing databases of the platform of the collection and delivery management system, in accordance with the first exemplary embodiment of the present disclosure.

FIG. 5 is a diagram describing 3^{rd} party services of the platform of the collection and delivery management system, in accordance with the first exemplary embodiment of the present disclosure.

FIG. 6 is a diagram illustrating the process of becoming a driver for the platform of the collection and delivery management system, in accordance with the first exemplary embodiment of the present disclosure.

FIGS. 7A-7C are a diagram illustrating process and computing architecture of the platform of the collection and delivery management system, in accordance with the first exemplary embodiment of the present disclosure.

FIGS. 8-9 are diagrams illustrating the process of becoming drivers for the platform of the collection and delivery management system, in accordance with the first exemplary embodiment of the present disclosure.

FIG. 10 is a diagram illustrating the process of creating jobs with the platform of the collection and delivery management system, in accordance with the first exemplary embodiment of the present disclosure.

FIG. 11 is a diagram illustrating the process of creating jobs using a coupon with the platform of the collection and delivery management system, in accordance with the first exemplary embodiment of the present disclosure.

FIG. 12 is a diagram illustrating the process of creating jobs with a promotion with the platform of the collection and delivery management system, in accordance with the first exemplary embodiment of the present disclosure.

FIG. 13 is a diagram illustrating the process of creating jobs with stores with the platform of the collection and delivery management system, in accordance with the first exemplary embodiment of the present disclosure.

FIG. 14 is a diagram illustrating the process of uploading item data with the platform of the collection and delivery management system, in accordance with the first exemplary embodiment of the present disclosure.

FIG. 15 is a diagram illustrating the process of address selection with the platform of the collection and delivery management system, in accordance with the first exemplary embodiment of the present disclosure.

FIG. 16A-B are diagrams illustrating the process of payment with the platform of the collection and delivery management system, in accordance with the first exemplary embodiment of the present disclosure.

FIG. 17 is a diagram illustrating the process of selection service with the platform of the collection and delivery management system, in accordance with the first exemplary embodiment of the present disclosure.

FIG. 18 is a diagram illustrating the process of applying a coupon during payment with the platform of the collection and delivery management system, in accordance with the first exemplary embodiment of the present disclosure.

FIG. 19 is a diagram illustrating way station architecture and database with the platform of the collection and delivery management system, in accordance with the first exemplary embodiment of the present disclosure.

FIGS. 20-34 are images of user interfaces and diagrams of way station identification, selection, and management within the collection and delivery management system, in accordance with the first exemplary embodiment of the present disclosure.

### DETAILED DESCRIPTION

To overcome the aforementioned deficiencies within the refuse collection industry and with the delivery of building materials and other goods by individuals who do not have vehicles capable of transporting such materials, the subject disclosure is directed to a system and method for collection and delivery of goods which utilizes modern wireless and computing technology to facilitate the management, collection, and delivery of goods. Specifically, with the advent of mobile computing devices with wireless communication, it is now possible to coordinate the efforts of discrete individuals to fulfill tasks customarily handled by organized, cohesive groups. From a waste collection perspective, using such a system allows for those in need of having refuse removed from their house or construction site to coordinate such a task efficiently and conveniently. From a goods delivery standpoint, this system can allow those in need of having goods delivered to a specific location to coordinate such delivery by other individuals with capable vehicles. Moreover, such an effort can be achieved at a relatively low cost compared to the conventional methods. For example, the costs of disposing of refuse, such as ordering a dumpster or removing bags of refuse, or the costs of renting a delivery truck and delivering building materials or other items can be substantially lowered with the system of management, collection, and delivery described herein.

Accordingly, the subject disclosure, in general overview, is directed to a method, system, and apparatus for coordinating the management, collection, and delivery of items, such as refuse items, but also other items which need to be delivered. The system utilizes a mobile application (app) that offers convenient collection and delivery service which can be used by corporate users and individual users. For example, the system may be used easily by building and renovation construction contractors, but also applicable to homeowners and other individuals who require assistance with removing refuse. The system further utilizes independent individuals who own vehicles which are capable of collecting and delivering goods, such as pick-up trucks or similar vehicles. The mobile application allows people who are in need of collection and delivery to request the assistance of those who are capable of picking up and delivering the goods. The system may include and be facilitated, at least in part, by a software application which is operable on mobile computing devices of the users and which interfaces with a central API. The end result is a system which harnesses the potential of individual truck owners who can assist with the collection and delivery of goods for individuals in need of assistance, all of which is managed through an easy to use, convenient, efficient, and cost-effective management system.

The system may be implemented using a computer-implemented platform which is built and programmed to control interfacing between the various aspects of the system. Accordingly, the platform is an information technology (IT) solution consisting of various IT components and services, enabling users to interact with each other in different optimal ways to make the system function and produce satisfactory results for the users. The platform may be implemented as an application, which is run on a mobile computing device, such as a smart phone, or a website which is accessible through the Internet. An application may be a mobile application for iOS or Android mobile operating system, which allows users to utilize the platform anytime. Easy and friendly interface allowing to quickly create or accept jobs and get loads delivered fulfilling a consumer's needs. The website may be one or more web applications provided by the platform. There are several components of platform which are exposed as a website, among them are the user portal, the admin portal, a permissions management portal, a pro portal and several informative sites including general company and services information.

In accordance with this disclosure, a user may be any person or entity in the platform, including a human person or system account, who has the ability to interact with the system. For example, the user could be created by other users (e.g. users with administrative roles) during registration in the system. Users of the system may generally be understood as being either a consumer or a driver. A consumer is a user of the system who has a need to deliver a load. Generally, the consumer is a real person registered using the platform. Consumers create the jobs for the drivers to fulfill their requirements of the delivery need. Consumers pay for the delivery job through the platform. A driver is a user who owns the vehicle and/or trailer and is able to accept and fulfill consumer created jobs. Drivers must be able to pick up or deliver a variety of items, anything from new in-store purchases to used items from a consumer's home or business to online purchase or stores. Drivers may also need to haul junk and debris to the landfill or reusable items to donation centers depending on the load category. Drivers must meet certain criteria, e.g., be at least 18 years old and have a valid driver's license as well as car insurance and registration of a vehicle that also has a driver's name associated with it. Valid car registration and insurance are likewise required for trailers. Every user is able to sign up to be a driver and the platform includes all required processes for these purposes. The driver is responsible for loading and unloading the load. Each driver may be issued a netspend paycard, which is used to access money earned by the driver. Paycards are also immediately loaded with the estimated fees associated with an accepted driver's job, which allows to cover the tolls, fees, and landfill costs.

As noted, the driver must have a vehicle and/or trailer for carrying a load. A vehicle may be understood as any type of the following: motorcycle, passenger vehicle, van, SUV, truck, box truck, or any type of vehicle that is in good appearance and safe operating condition meeting the laws of the Department of Motor Vehicles. The type of vehicle the driver owns may affect the types of jobs the driver can be assigned to by the platform. The driver may also have a trailer, which is owned or rented, and which may act to increase the delivery capacity of the load. The trailer can be rented on a short term basis with proof of contract and valid permission for commercial use. The trailer must be registered, and the contract must be in the name of the driver as associated with the driver account, and also be listed on the driver's personal insurance.

The job may be any type of delivery request from the consumer using the platform. The job may contain a list of loads to be delivered with their exact sizes and weights. Paid jobs are ready to be accepted by drivers through the platform. The platform automatically displays jobs to the drivers with matching haul capabilities calculated based on vehicle parameters. A job is complete when loads are delivered by the driver and it is confirmed by the consumer. In many cases, the job may be to deliver a load between two locations, identified herein as point A and point B. For example, point A may be a pick-up location of delivery starting point, where loads have to be picked up by the driver. Consumers may define delivery starting points by using the platform. The load may be delivered to point B, which is the delivery end point. Consumers may define delivery end points easily by using the platform, or in some cases, the platform defines the delivery end point, e.g., when the load is to be disposed of and the consumer does not need to decide which landfill or way station the load is delivered to. A way station is a place having a location which is added into the platform by an administrator of the platform. This location is later used for one of the platform key features—automatic closest matching delivery location for junk or debris types of loads.

The load may be one or many physical items that have to be delivered from point A to point B. The load could be any physical size or weight. Using the platform, the consumer is required to submit the weights and sizes of the items to be picked up or delivered, and the platform calculates what size vehicle is required, as well as any additional special equipment and/or helpers needed, and matches these requirements with an available driver. The platform takes all the information from the order request to match the load based on certain criteria, such as the size, weight, and images of the items listed in the job, the most appropriate driver and vehicle available, the location of the driver closest to the pick-up and delivery locations, whether or not a helper is required.

The platform may operate in several unique geographical areas, which are defined as areas of operation. For example, the platform operates in the United States, and each state is considered as a unique area of operation. The platform allows it to be configured and maintained independently. Administrators could also configure specific map zones in each State and manage them separately, e.g. only allowing certain city areas to be operational by the platform.

In use, the system, as implemented by the platform, allows consumers to have loads delivered from point A to point B using a driver's help. The platform provides all required services in-between the consumer and the driver to solve a consumer's problem quickly and in the most convenient way and time. The process starts when the consumer needs to deliver a load which cannot be delivered by him or herself. The consumer opens the platform, such as through a mobile application or through a website, and creates a delivery request. The platform receives this information and analyzes the location of the consumer and driver, the size and/or weight of the load, etc. The platform then provides the consumer a price and issues a job to the driver after payment by the consumer. When payment is received, the job becomes visible to the drivers which fit the job requirements and they could accept the job. By accepting the job, the driver is required to pick up items from point A and deliver them to point B. During that period, the consumer may track where his load currently is in transit using information provided by the driver's application GPS data. When the load is delivered to point B, the consumer confirms delivery is complete, which ends the job. The driver gets a certain amount paid to him on his paycard and is now eligible to use this money. The platform acts as an interfacing system which controls the money flows and collects service fees for the delivery. The platform may have a flexible configuration on the rules on how these fees are calculated.

While the system and platform through which it is implemented has been described in general detail, specific details about parts, portions, modules, and functionality of the system are described below.

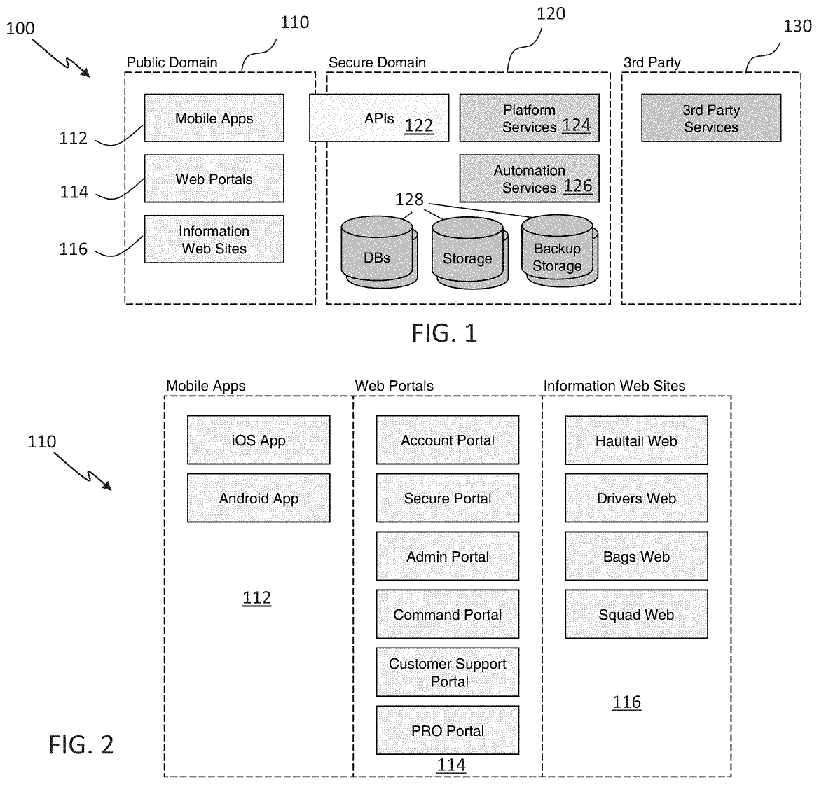

The platform is described relative to FIG. 1. As shown, the platform, which may be referred to herein as a system, may include multiple components which allows it to provide services between consumers and drivers to deliver loads, as described herein. Components of the platform include hardware and software components which are hosted on dedicated servers with the appropriate maintenance as well as critical services hosted in a cloud computing network, which allows the platform to fulfill 99.9% services uptime requirements. The components of the platform are created using an IT architecture and technologies which allow for easy maintenance and upgrades. As shown in FIG. 1, one embodiment of the platform is implemented in diagram 100, which has a public domain 110 having mobile applications 112 for accessing and using the system via a smart phone or mobile device, a web portal 114 for accessing the system using a desktop or laptop computing device, and an information website portal 116 for providing information to the user concerning the system. A secure domain 120 includes components used to conform the platform such as APIs 122, platform services 124, automation services 126, and various databases 128 for storing data. The platform also has a 3^{rd} rd party domain 130 which can be used by 3^{rd} party services, as needed.

The public domain 110 is shown in greater detail in FIG. 2. As shown, the details of the public domain 110 are provided within the mobile apps service 112, the web portals service 114, and the information websites service 116. The mobile apps service 112 may include interfacing components for any type of mobile computing device, including those operating on iOS or Android, or another operating system. The web portals service 114 includes an account portal, a secure portal, an admin portal, a command portal, a consumer support portal, and a PRO portal. The information websites services 116 includes a platform web (identified under the commercial brand name ‘Haultail’), a drivers web, a bags web, and a squad web.

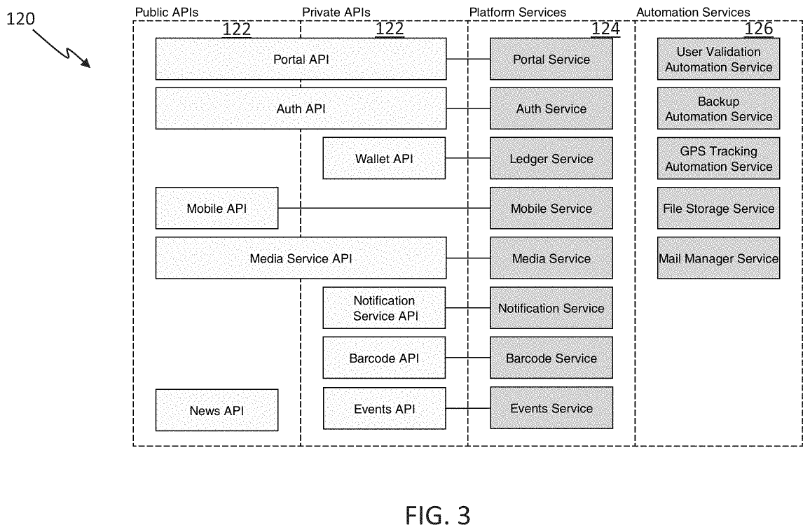

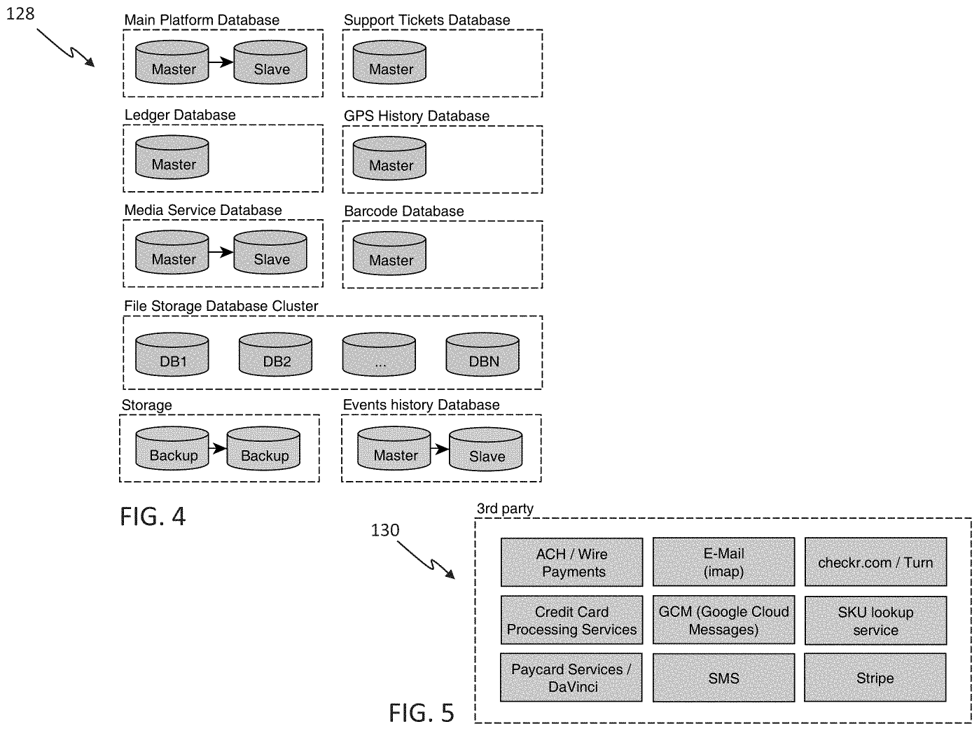

A microservice architecture allows the platform to be flexible and robust. Microservices use APIs and communication protocols to interact with each other, but they don't rely on each other otherwise. This architecture allows IT teams to develop, maintain, and deploy each microservice independently, which increases service stability and maintainability, and allows for quicker updates and modifications to the system. FIG. 3 is a diagram 120 showing the domain components within the platform's web portals 114 microservice architecture. As shown in FIG. 3, the APIs 122 may include public APIs and private APIs, which provide a portal, API authentication, a wallet feature, mobile API feature, media service, notification service, barcode service, and news. The platform services 124 may include corresponding services to each of the API feeds in the API 122 block. The automation services 126 may provide various automation of the system, including user validation automation service, backup automation service, GPS tracking automation service, file storage service, and mail manager service. Many of the services use databases, and there are several databases used across the solution. Depending on the platform needs, databases use different stability and access architecture and approaches. FIG. 4 illustrates a diagram of an example of the databases 128 used within the platform. The databases may have a master-slave relationship, and slash or be arranged in a cluster architecture. In one example, the databases may include databases 128 for the main platform, ledger, media service, file storage, support tickets, GPS history, and barcode.

It is noted that some databases use replication, some use duplication, others are less important and just have an automated backup. There are also other types of storage used within the platform which are host machine disks and backup storage. The host machine disks and storage may include a variety of options depending on deployment, including those which are known in the art, and therefore not described herein. FIG. 5 illustrates a detailed diagram of some components of the 3rd party services 130 block, including external services which are integrated into the platform using 3rd party APIs and communication interfaces. As shown in FIG. 5, there are three main groups of services: (1) payment processing and handling services, (2) communication services and (3) various validation services. 3rd party services are compositely integrated with platform secure domain services to provide optimization to certain workflows.

There are several components in the platform which are used to make the system functional, which is primarily constructed from a combination of websites and mobile apps.

Mobile applications are designed for use by the consumers and drivers to enable these users to coordinate the pick-up and delivery of items between locations. Currently there are two main platforms supported: iOS and Android which allows the system to cover the most part of the mobile market. Mobile applications are part of the recurrent update cycle and capable to force users to upgrade the application on the platform version changes. These have the most functionality and cover all the required workflows described in this document. Mobile applications are key parts of the platform as these enable users to easily and quickly access the services provided by the system. As an alternative to using an app, a user can also access the system through a website. Different websites may be used for different types of users or other people accessing the system. For example, these different websites may include a main landing page, a page for drivers, a page for branding, a user portal, a portal for PRO users, an account management page, and an administrative page, among others.

The system may be used by the users to provide various services, as coordinated through the platform. These services may include:
Courier service. The courier service allows consumer urgent deliveries to be handled. Consumers can have a local courier, who is available to him on-demand, deliver his packages locally. Couriers can be scheduled in advance. They can be at the pickup location at a time of the consumer's choosing, including evenings and weekends. The platform will connect the consumer with local, on-demand couriers. Items will be delivered the same-day by local shipping and courier experts. Consumers can arrange this courier service using the platform app with the tap of a few buttons on the iPhone or Android to hire a delivery professional who will courier their items. The courier service may be ideal for important documents, same-day local letter or mail, a last-minute gift, a forgotten item, small parcels, packages, retail purchases, or banker's boxes, among other items.
Online delivery—The platform has an online delivery service which allows buying and selling online easier than is conventionally available. While services like Craigslist, Offerup and Letgo make it easy to arrange a sale, meeting the seller or buyer is not always as easy, due to logistics, security concerns, etc. That is where the platform's online delivery service comes in. The platform is able to deliver a consumer's items to a buyer, or even deliver it from the seller to a consumer.
Store pickup—A consumer's retail purchases can be delivered, on-demand. In case a consumer demands fast delivery from retailers, whether buying online or buying in a brick and mortar store, a driver using the system can go to any retailer to pick up the consumer's item and deliver them to the consumer. Consumers are not limited by the size of their vehicle. They can buy a big screen TV, or the overstuffed couch, or even construction supplies and use the platform to deliver it. The platform covers retail delivery service from any retailers' in store pickup, curbside car service, drive thru loading, etc. This service may be beneficial for consumers who are purchasing boxed items, furniture, appliances, gardening supplies, construction supplies, or any other large item.
Storage moves—A consumer is able to move items into storage or out of storage. The platform will help them to pick up and deliver their items, both large and small to and/or from their storage unit.
Bagged construction debris—Consumers are able to purchase bags for construction debris which they can then fill with junk or debris and arrange for pickup through the platform. The consumers may be able to receive discounts when using bags which are manufactured by associated partners of the platform, whereby a user can utilize a UPC code or similar proof of purchase to enable a discount from the platform. Additionally, the system may utilize special trucks and drivers that could haul junk and debris.
Landfill and dump items, junk and debris—The platform provides a service to haul junk and refuse for a consumer, and ensure that those items are disposed of properly. Consumers can place the refuse in bags, or otherwise have it available for pick-up. This service may be ideal for items such as trash, refuse, and garbage items, such as old bedding, damaged electronics and furniture, old appliances, green yard waste, construction waste and debris, including raw materials (concrete, dirt, etc.) and building supplies, recycled materials, car parts, and others.

As noted previously, the users of the system are generally the consumer and the driver. The roles of the consumer and driver, along with their obligations and responsibilities, are described in more detail herein. The consumer's role is to describe the need of delivery in a form of request through the platform which then will be transformed to a job by the platform. The consumer may access the platform through a mobile application or website and use the interface presented by the platform to submit the information for job creation. For example, the consumer will specify details of the load items it needs to deliver, such as the type of items, the quantity, the weight, the dimensions, or other characteristics of the items. Consumers must provide access to the items for the drivers, such that the drivers can pick up the items. The driver's main role is to fulfill the consumer's need in delivering items. The driver defines his capability for picking up the load by describing his vehicle parameters. These submissions are checked by the administration of the platform. Checks and validation is part of becoming a driver process which is described below.

There are several types of drivers which the platform supports, including a standard driver, a lead driver, and a pro driver. The standard driver (or “driver” as described herein), is a default first level driver which any user may apply to be. A lead driver may be assigned to specific regions or geographic locations. Each region has lead drivers who assist with finding jobs and performing in-store functions. Being a lead driver also requires the user to be “on call” in the event that the platform is unable to match a driver with a submitted job request under the service window time-frames. While a standard driver performs local pick-up or delivery for a single consumer in distances up to about 20 miles, a pro driver can do multiple in-line deliveries and/or haul longer distances and do backloads picked up by the leaderboard.

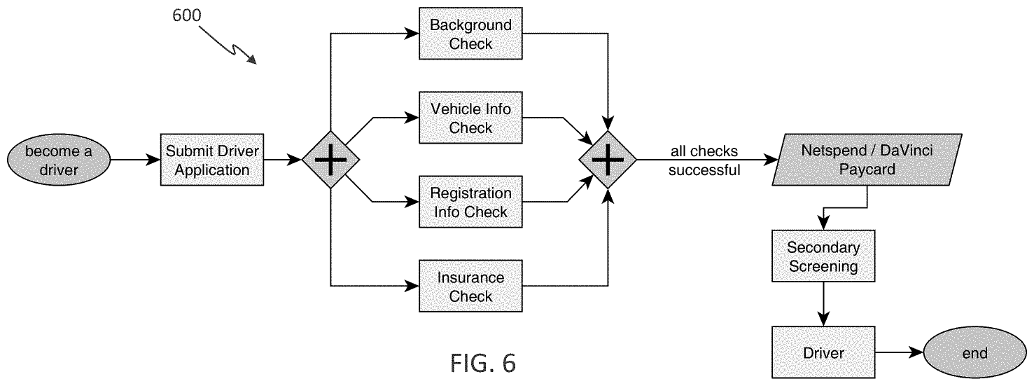

To become a driver, a user must initiate the process on the platform, which includes providing information to the platform. The administrative personnel of the platform then reviews, validates, and confirms the user's ability to become a driver. FIG. 6 illustrates a diagram 600 which outlines the process for becoming a standard driver. A user may first download the application in the Android or Apple store and goes to the main menu and clicks the button that says ‘Driver’. There, the platform prompts the user to supply information to qualify him to be reviewed for approval. Generally, this information includes:
Over the age of 18 and have a valid state-issued ID
Be authorized to work in the U.S.
Must be available in the area applying to work
Have the proper size vehicle for the work being done; SUV, Pickup Truck or Cargo van
An iPhone or Android capable of running the latest app
A valid driver's license
Able to pass 3rd party screening of background and driving record
Current Auto insurance in your name registered for the vehicle applying to us.
Ability to lift and carry objects of up to 75 pounds
No felonies or violent misdemeanors in the past 7 years
A reliable and 5 star attitude
As the platform operates in different areas of operation, there might be different rules to the applicants. Detailed rules for each area could be found on one of the websites, such that the user can review the rules to ensure they comply with them. After submission of the application and providing the needed information, the administration of the platform may perform a background check of the driver in the following areas:
   Person background check
   Vehicle information check
   Registration information check
   Insurance checks
Upon successful checks, the system issues a Netspend Paycard to the driver and invites the driver to the secondary screening interview. When the checks and screening interview are successful, the user becomes a standard driver and may now accept jobs.

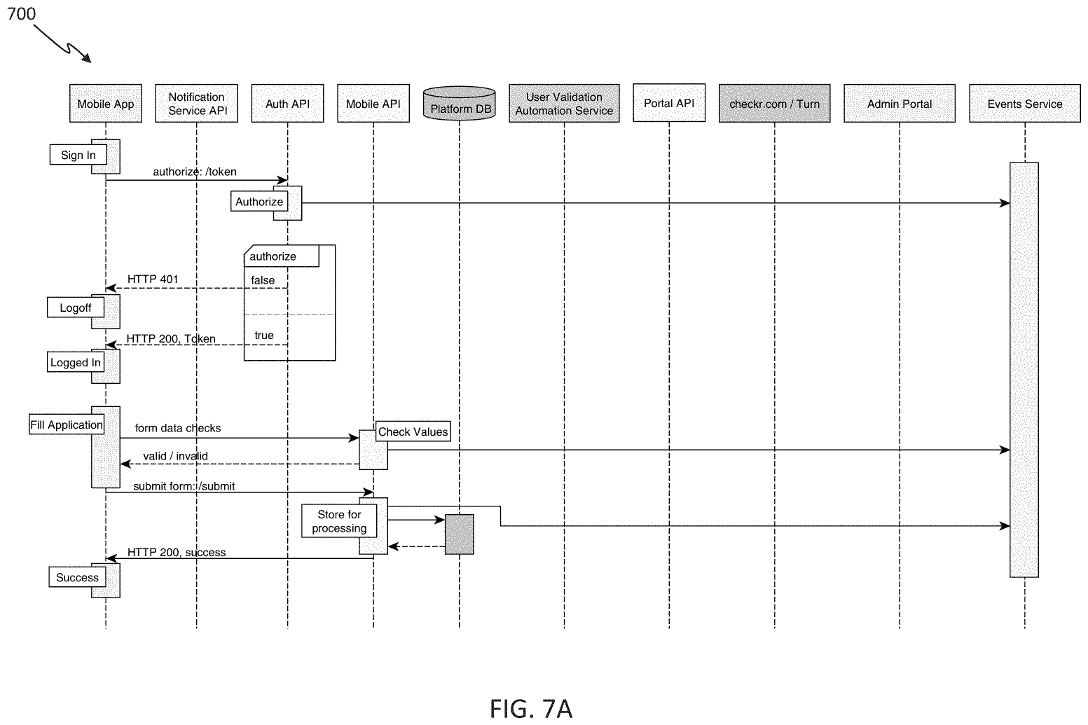

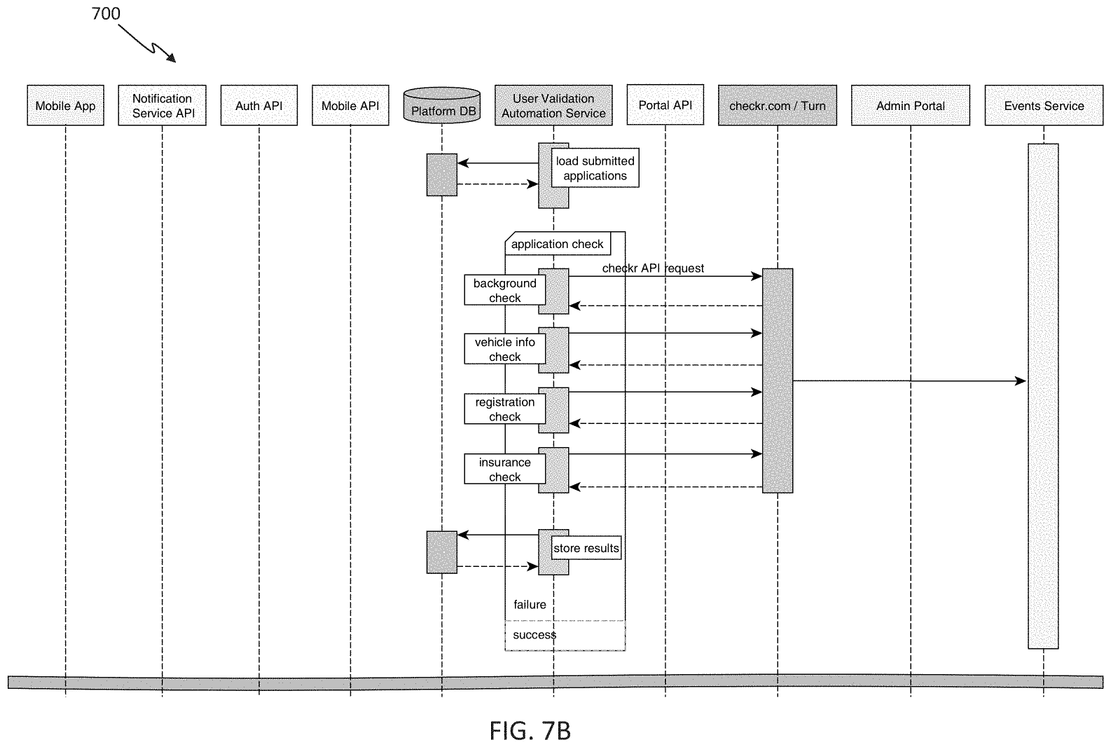

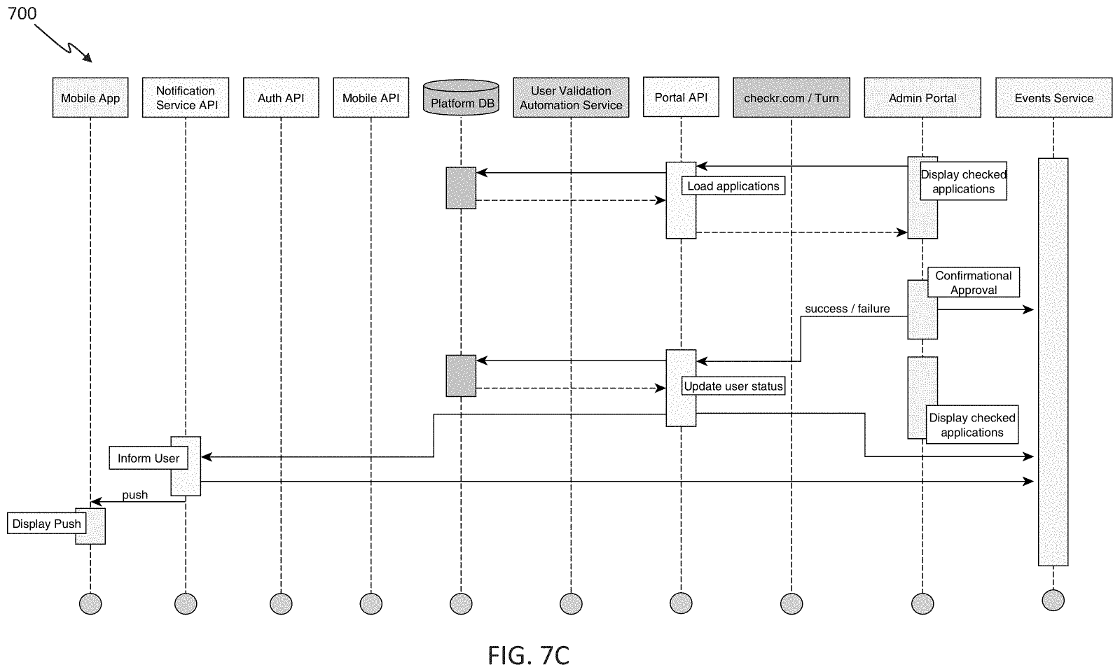

A detailed diagram of the process and the computing architecture and/or processing which handles specific functions thereof is shown in diagram 700 in FIGS. 7A-7C. As can be seen in FIG. 7A, a user can sign in using the mobile app. An authorization token is communicated to the authorization API, where authorization is determined to be false or true and a corresponding protocol action is taken. For a user that has logged in successfully, the user may fill out an application, the values of which are checked, and that application may be submitted for processing within the system. Next, as shown in FIG. 7B, applications may be loaded. The process includes an application check for a user which includes a background check, such as through a checkr API request, a vehicle information check, and registration check, and an insurance check. These validations are needed to ensure a user can participate in the system, and the results are stored as being either successful or not. As shown in FIG. 7C, applications are loaded from the database and displayed within an administrative portal. Confirmational approval may then be completed which updates any user status within the database. If successful, the user is informed, and a push message is sent to the user through the mobile application.

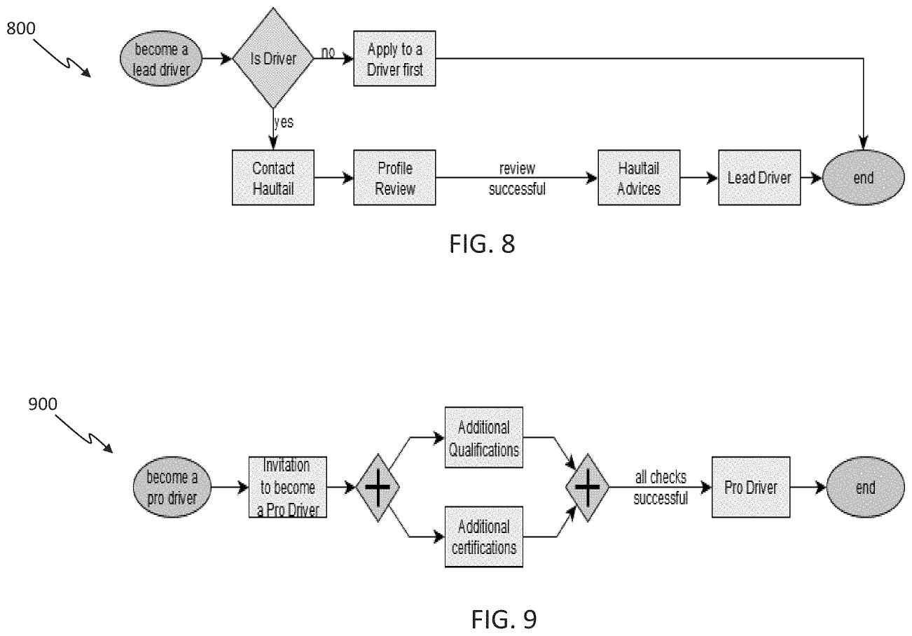

FIG. 8 illustrates a diagram 800 which outlines the process for becoming a lead driver and FIG. 9 illustrates a diagram 900 which outlines the process for becoming a pro driver. As shown in FIG. 8, once the driver applies, the system is contacted, the user's profile is reviewed and if successful, the user is given access to the system as a driver. And, in FIG. 9, pro drivers are generally given an invitation, and their qualifications and certifications are reviewed prior to them attaining the status of a pro driver. Generally speaking, lead drivers have the opportunity to get more difficult jobs and therefore earn more money. Pro drivers are assigned by invitation only and require additional qualifications, including certifications with the Department of Transportation. The platform's administration may offer the best drivers, in terms of responsibility, the option to become a pro driver. These drivers will be offered additional qualification tests to be passed and asked for additional certifications. Pro driver status gives the driver an opportunity to do multiple in-line deliveries and/or haul longer distances and do backloads picked up by the leaderboard and as result earn more money.

Once a user is approved as a driver, the driver has the ability to accept jobs which are populated in the platform. Jobs appear in the driver's section of the platform and they are filtered by the driver's characteristics and capabilities, for example, the driver's location, the amount of items a driver can carrying in their vehicle, the amount of weight a driver can lift, etc. Jobs are never assigned to a driver whose vehicle parameters do not fit the job request. The driver may accept or ignore the job. When the job is accepted by a driver it disappears from acceptable job lists, thus preventing duplicative jobs being listed.

The administration of the platform has an active role throughout the service process. For example, the administrative role of the platform is to control the system behavior and all interactions between the consumer and the driver through the platform. There are different levels of administrators in the platform. Access to certain platform administrative areas may be assigned or removed by a super administrator, who serves as a lead administrator. The super administrator is an administrator with full access to the system. In most cases this is a system account which should not be used by users. A super administrator account is available in terms of system maintenance and in some cases automation operations.

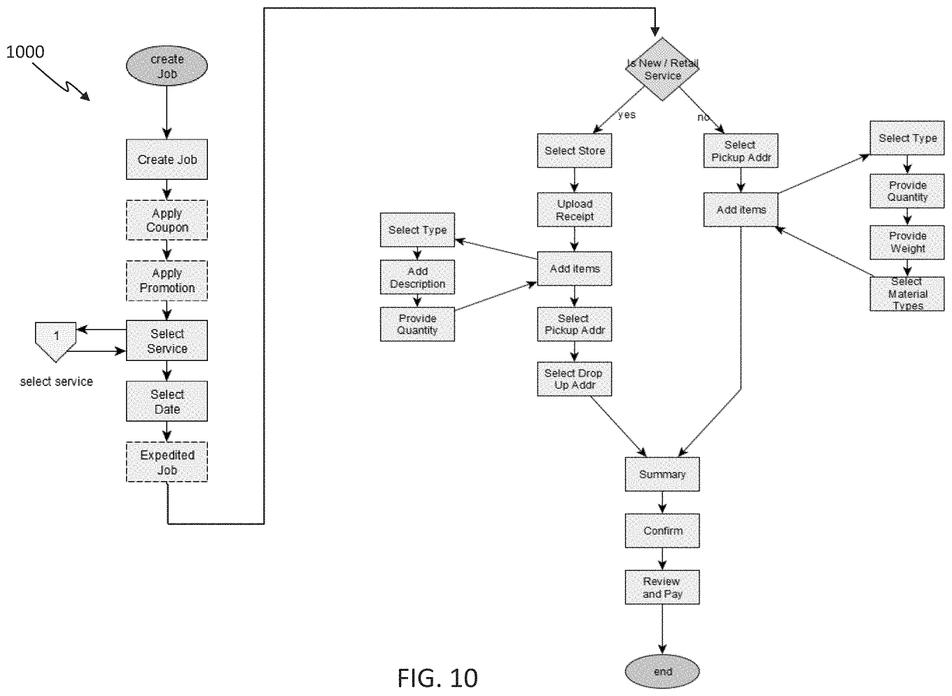

The interface between the drivers, the consumer, and the administrator are the jobs, which, in general terms, are created by the administrator based on the information provided by the consumer, and which are provided for drivers to accept. Jobs describe what item or items have to be delivered, to where and when, among other parameters. Depending on types of jobs, jobs may have a different creation processes. For example, in some situations, jobs may be created only by consumers. This process is described in diagram 1000, as shown in FIG. 10. As can be seen in FIG. 10, a job is created by an individual seeking to use the system for deliveries or other actions. The user may apply a coupon or promotion, select any ancillary services, select the date of service, and determine whether the job should be expedited. If the job is a new or retail service various additional information is collected by the system, such as the store or the pickup location. When the service is for picking up items at a store, the user may upload a receipt which visually displays the items or their identifying information, such as a product identifier, a UPC code, a barcode, a model number, or a serial number, or similar identifier. The system can use an image capture technique to review the visual image of the receipt and automatically determine the type of product that needs to be moved, the quantity of products that need to be moved, in any relevant description. The drop off or delivery address is then populated within the system, a summary of the job is generated for user confirmation and collect payment. When a job is for picking up items at a non-store address, the user may input data about the product to be delivered or picked up manually, including identifying the type of product, the quantity, the weight, or any particular materials within the product. Again, a summary is created for the user to confirm the job and provide payment.

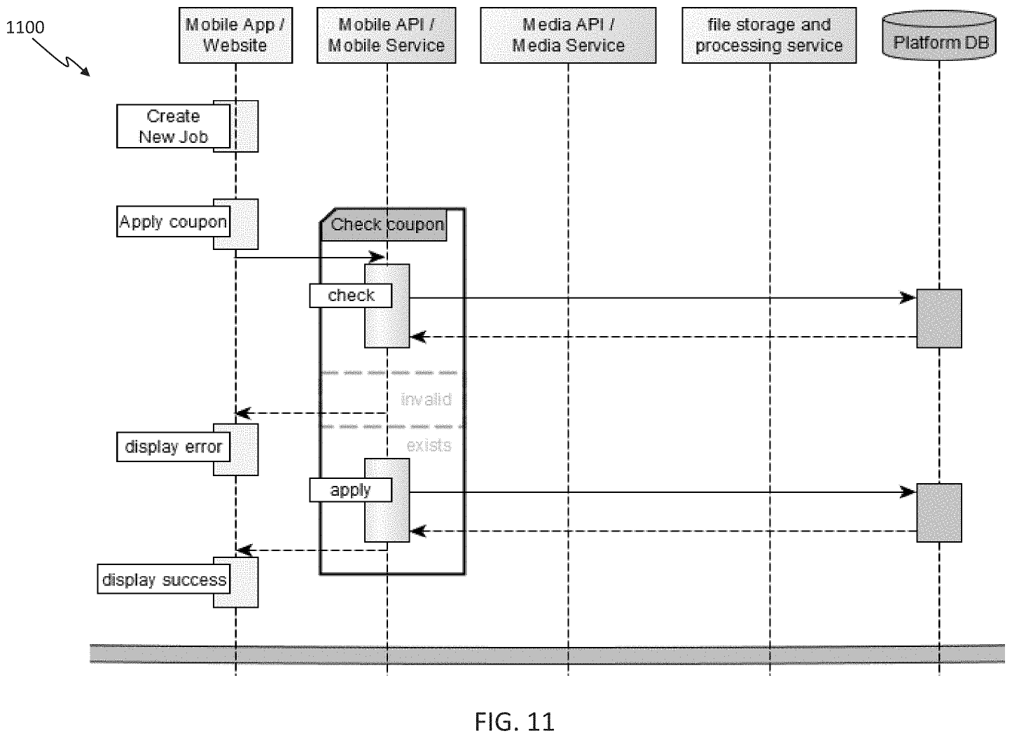

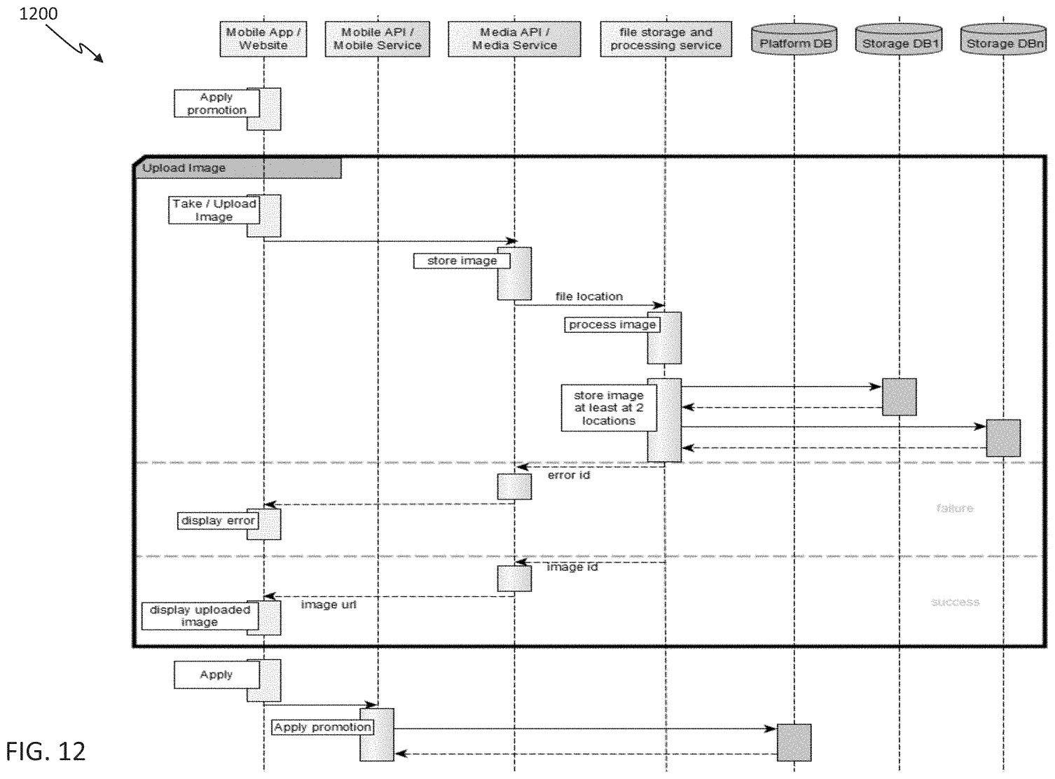

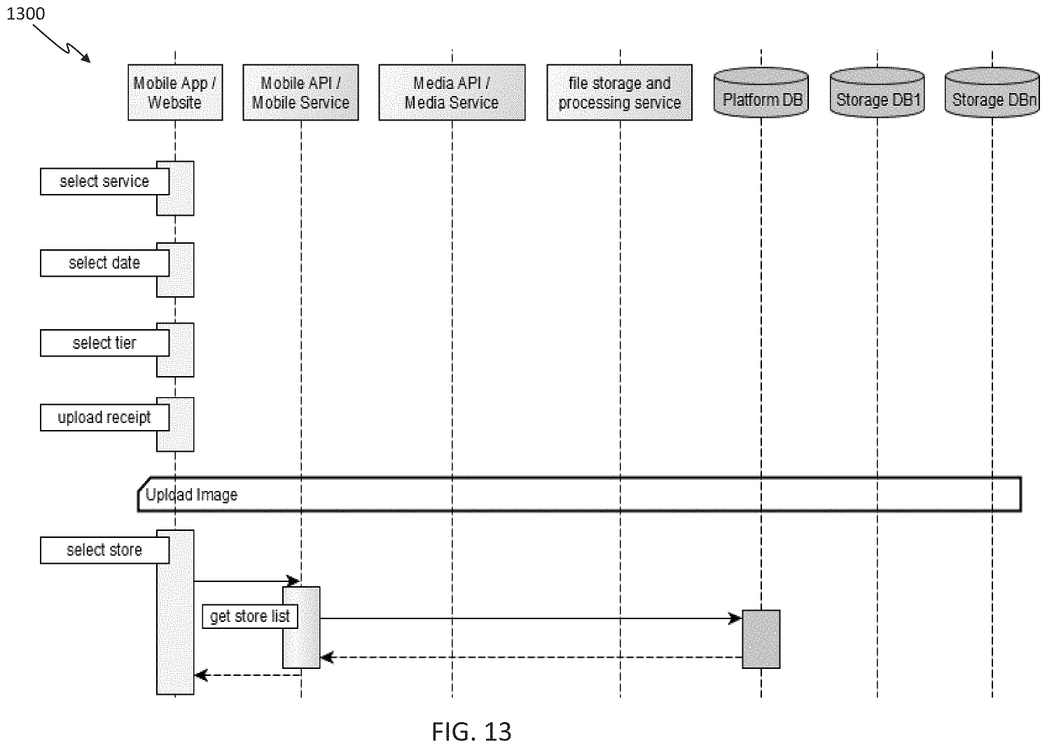

Naturally, the process for job creation may include many other aspects and processes. For example, the job creation process may start from the user clicking a button on the platform interface for creating a new job. The first option for the user is to apply a coupon. FIG. 11 illustrates a diagram 1100 which shows the job creation process and application of a coupon. As can be seen, when a user applies a coupon, a coupon check is performed with the platforms database. A result is provided either showing at the coupon was applied successfully or not applied successfully. Similarly, FIG. 12 illustrates a diagram 1200 which shows a detailed diagram of the job creation process with application of a promotion. As can be seen, a user may upload an image with their phone or other computing device, and the image may be stored and processed within the platform. Often, the image is stored in duplicative databases. If the promotion is accepted the user is notified, and if the promotion is not accepted the user is given an error message. Accepted promotions are then applied to the job. These two diagrams illustrate the steps for applying a coupon which the user has, or for using a promotion code when first creating a job.

The next step in the job creation process is to select job parameters, including the service type, time frame, the tier, a store selection, if applicable, and uploading a receipt, if applicable. The inclusion of a store selection and uploading a receipt may be applicable if the user's job is to have the driver pick up an item or items from a store, such as a home improvement store, and have it delivered to a desired location. In this situation, the store selection and the receipt upload may be used to provide information to the platform or pre-populate criteria of the job. For example, the receipt upload will identify the items, such as by UPC code, which can then be used to identify weight and dimensions of the item. Diagram 1300 in FIG. 13 illustrates the job creation process with regards to stores. As shown FIG. 13, the user uses their mobile app or the website to select service, select a date of service, select a tier of the service, and then upload a receipt of their purchase from the store. The image is uploaded to the system and various information is determined, including the store and its address, which may be populated from a list of stores saved on the database.

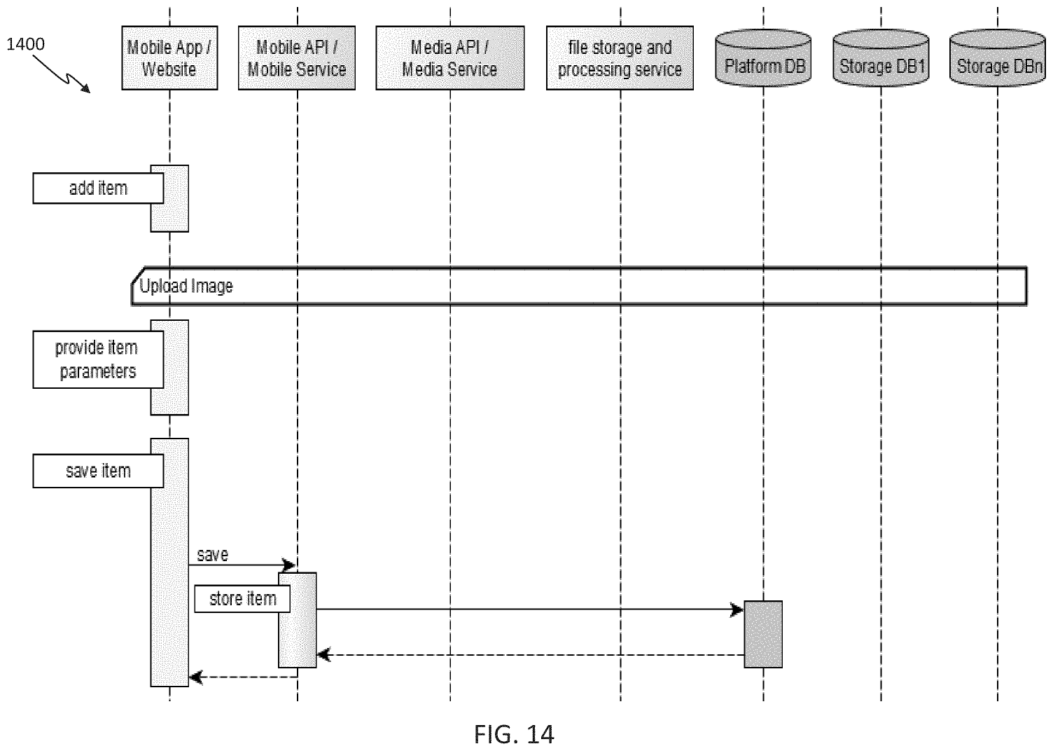

The consumer then is prompted to provide details of the item or items he needs to transport. If the details of the item(s) cannot be achieved through other avenues, such as a receipt, the consumer is required to provide item photos, sizes and approximate weight, so the platform may further match the best driver for these items added. Diagram 1400 in FIG. 14 illustrates this process. As shown the user can manually added item with the mobile app or the website, and/or they can upload an image of the product, or of the receipt. The user may then provide item parameters, such as weight, size, dimension, or material, among other parameters, and the item is saved within the database.

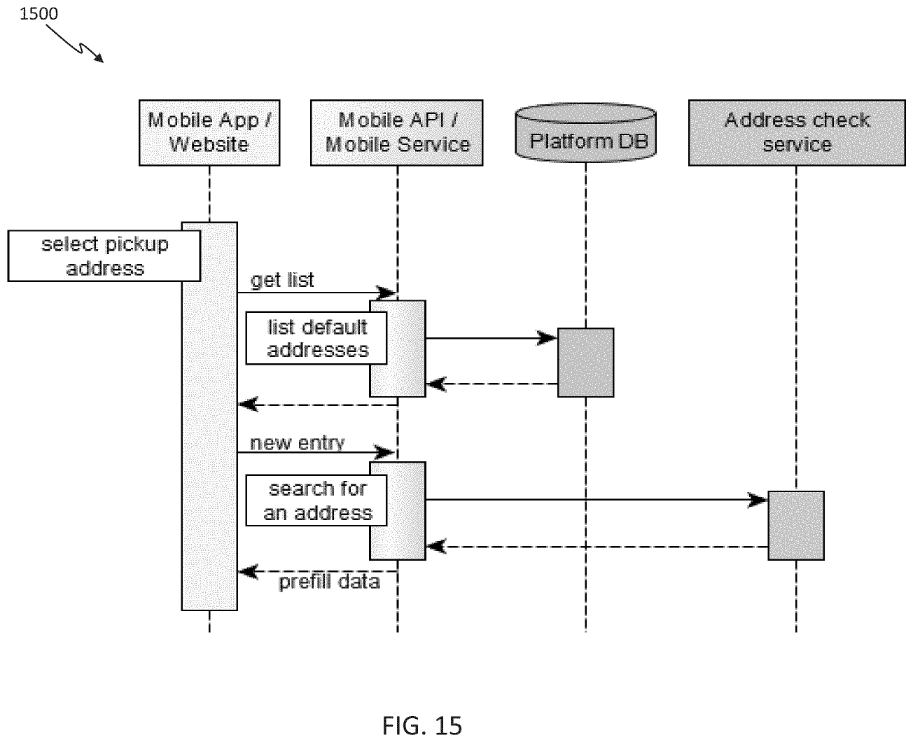

After items are added, it's time for picking up the address of the destination delivery. Consumers may select from a list of previously saved addresses or create new ones. Diagram 1500 in FIG. 15 illustrates this process. For instance, the user may select the pickup address from a list of addresses saved within the system. A user can select one of these default addresses, or the user can enter a new entry and search for new address. An address check service is used to determine if the address is legitimate, and that service may use prefilled data within the users screen on the mobile application or website.

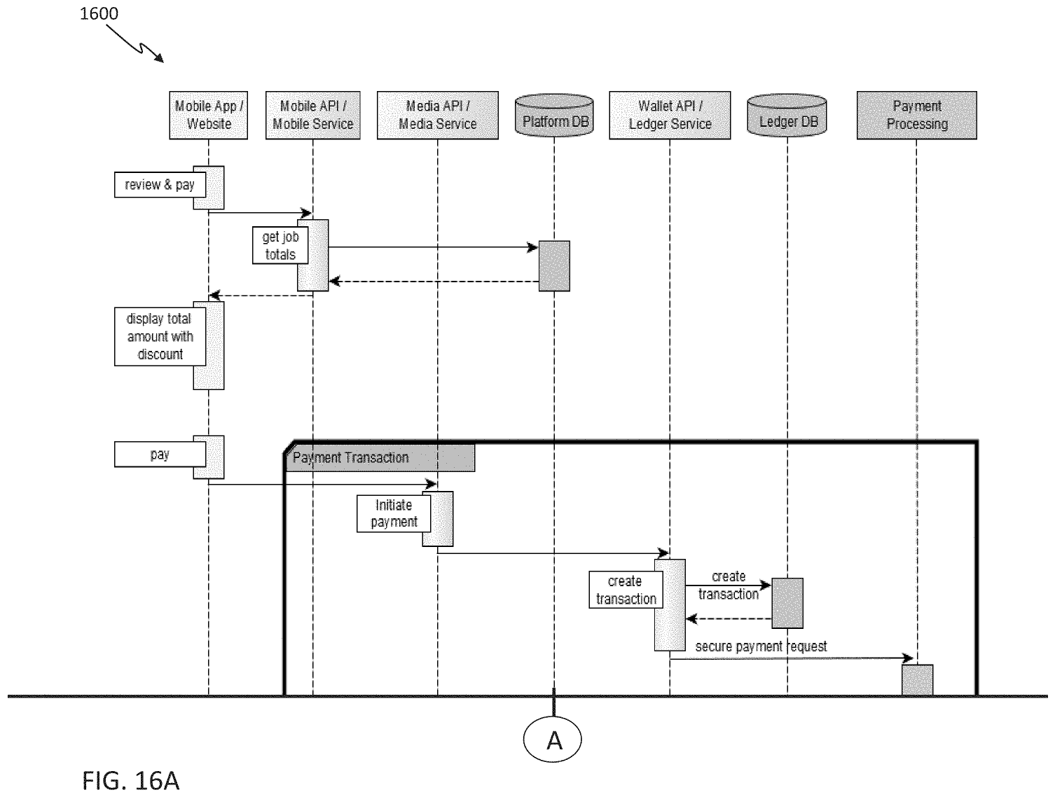

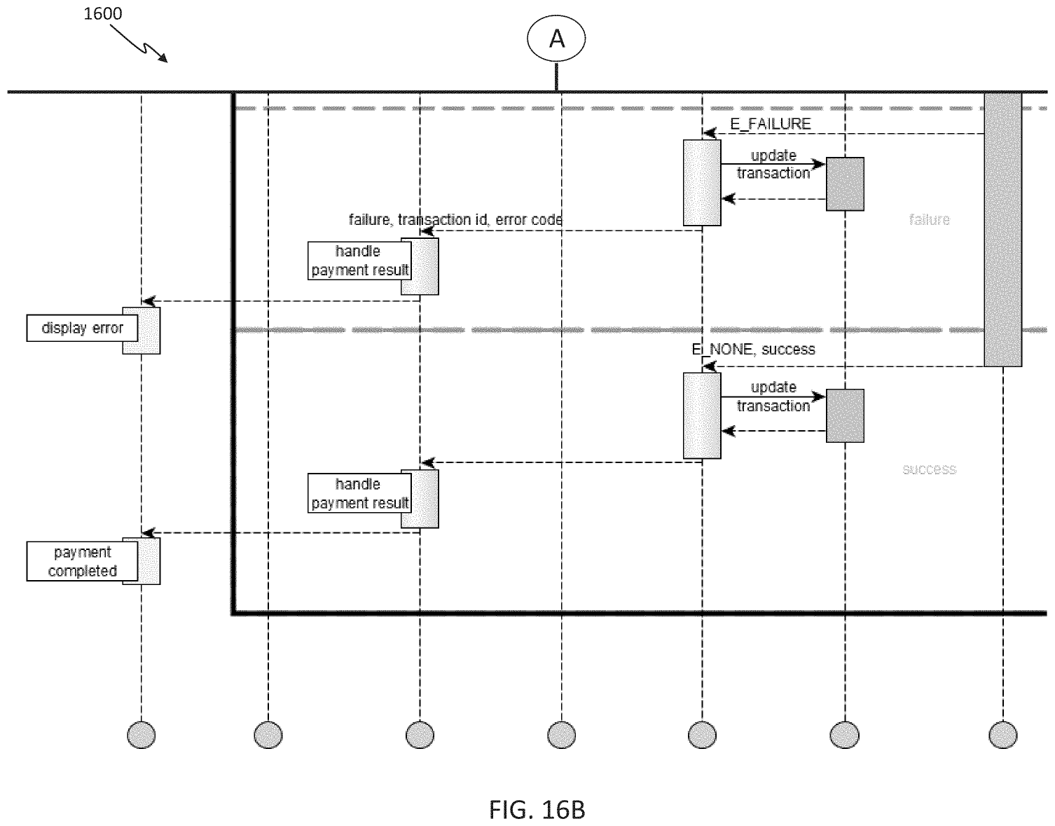

Once the delivery destination is determined, the next step is to process payment. Processing payment is a complex process, but the platform's microservice architecture is very easy to connect payment service providers. This process is described in diagram 1600 in FIGS. 16A-B. As shown, the user may review and pay through the mobile app or website. The mobile API may determine the job total which is stored within the database and that amount is displayed to the user, along with applying any discount. The user then submits payment, the payment transaction is initiated. The system creates a transaction within the wallet which is saved within the Ledger, and the secure payment request is submitted to the payment processing block. Continuing, as shown in FIG. 16B the payment processing lock either provides an indication of success or failure of the transaction. A failed transaction is given a transaction ID and an error code which is communicated back to the user to display the error. For a transaction that is successful the transaction is updated within the Ledger and then payment is completed by confirming with the user that the payment was successful. It is noted that the platform can accept payment via a variety of different methods, including credit card, ACH, or other forms of payment. The platform never stores any credit card related data, and that the platform follows PCI DSS security standards.

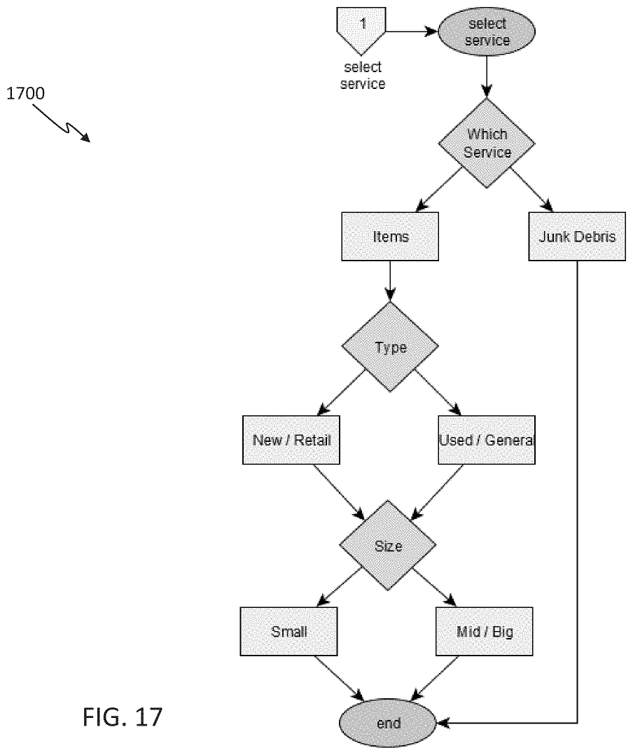

Once payment is confirmed, the next step is service selection. Service selection is a part of the job creation process, which is generally described in diagram 1700 shown in FIG. 17. As shown, a service is first selected. This may include pick up or delivery items, or pick up of junk, debris, or refuse. There are several job types the consumers are able to create. These include new retail pickup, courier delivery, used moving of items, junk and debris pickup, and donation drops. For the pickup of items, selection may be divided into items that are new and from retail stores, or items that are used. The size of the item is considered in the system as well. Based on the job type and its automated description within the platform, the right sized vehicle for transportation is selected. For example, a job requiring movement of a large appliance, such as a refrigerator must be assigned to a truck or van which is capable of hauling an item of that size and weight. Similarly, a job which requires the removal of larger items, such as concrete rubble debris, may require the use of a vehicle with a dump body. The vehicles may include any type, and are generally classified into a 6-tier vehicle system, which is coordinated with the proper amount of human labor required to satisfy the load and/or any identified conditions or prearranged requests. For example, a job moving a heavy appliance may require two or more individuals (a driver and a helper). The selection of the vehicle and the human labor is based on the type of job and the proximity of the pickup and delivery location(s).

Jobs for new items are classified as not having prior use and new for consumer use, if from a direct retail outlet or a big box distribution hub. Within business to consumer use, of the two categories (new smaller items or new larger items), big and bulky items are selected and defined through the order process in the app, accompanied by some proof of purchase, order number and/or receipt allowing the driver to retrieve. For business to business and business to consumer use, new items may be identified by bill of lading and allows commercial multi-inline drops, from warehouse to store or warehouse to consumers with electronic proof of delivery.

Jobs for used items are based on two categories: either courier sized deliveries or mid-to-large items (including big and bulky transport). Several additional or add-on services can accompany used items, such as white glove service, assembly/disassembly or the range of time, taking longer than that of just a pickup and drop-off. Business to business and business to consumer are treated the same with this class of job, with a ‘to’ and ‘from’ destination accounting for any circumstances, the sensitivity to time and any additional labor required.

Junk, debris and donation jobs are identified by the non-hazardous items looking to be disposed of If items are able to be repurposed and allowed, the items will be mitigated for donation drop if not previously recommended. If the load is a mixed load for landfill and donation, they are treated as two separate jobs as they go to two different locations. Calculation of cost attributable to multi jobs compared to single job is taken into account. All jobs for waste disposal are directed to certified way stations and centers from a unique database within the platform, which confirms the cost, rank, rate, conditions, times of operation and locality, such that the items within the load can be matched to the appropriate location. All debris jobs have confirmation of the actions required by the driver and vehicle based on geo-fenced criteria being satisfied in the application in order to proceed and/or conclude a job.

With job assignment, all jobs may be assigned by the platform administration. Special interface is available to the administrator where he can easily match required available active drivers and assign the job to one of them. The driver will see the new job notification in the app and be able to accept the job.

The system may use a contactless pin code system to create a delivery where the driver and consumer are distanced from each other. To confirm delivery and release the delivered items, the consumer provides a PIN code generated by the platform to a driver to complete the delivery. This allows for the delivery to be completed in the event that the consumer is not around. The PIN code might be taken as a kind of electronic signature, or other identifying information which can only be received from the consumer.

The system may use coupons which are created by the administrator. There may be several options of how these coupons could be created. For example, there are generally two types of coupons the administrator is able to use while creating:

| Type | Description |
|---|---|
| Percentage | Percentage would affect Job total amount value |
| Fixed Amount | Fixed amount allows to just apply this value as |
| | discount to the total Job price |

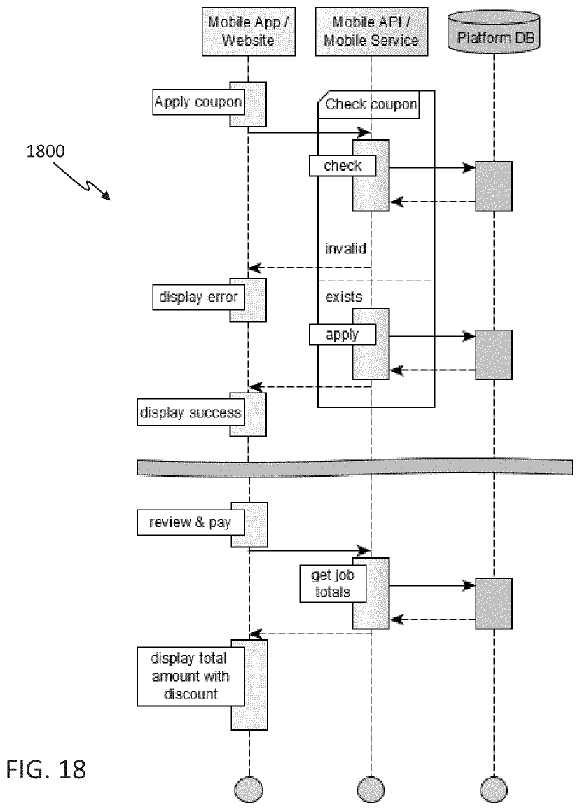

There is a possibility to fix the coupon to a specific driver or consumer accounts, which allows not only to create public advertisement scenarios, but also provide specific users more tools to advertise the platform within their own campaign. For example, drivers may get their own coupon, which will work only with this specific driver allowing the driver to give a discount for his delivery. Coupon activity could be limited within a certain selected timeframe as well as by the number of uses of the coupons. Diagram 1800 in FIG. 18 provides an illustration of the process for applying a coupon during job creation. Specifically, a consumer applies a coupon within the platform by navigating to “PICKUP & DELIVER MY ITEMS” section of the application. The consumer then clicks “Create” on the bottom left corner of the application, clicks apply coupon and enters the coupon string of code. The consumer then proceeds to scheduling the job and paying for the job. If a coupon is applied and accepted, the discount will be applied to the total amount.

Similar to coupons, the system may offer promotion, which is a discount that consumers are able to get in case there is some discount campaign running with partners. For example, the promotion feature may be used with the co-branded construction debris bag (branded as ‘Haultail’ bags), which allows bag buyers to get a promotion discount on the delivery. To get the discount, consumers need to add photos of the receipts buying these Haultail bags.

In addition to coupons and promotions, it is possible for consumers to give drivers tips. Consumers may be required to provide ratings to drivers upon completion of the job, but they can also tip the drivers after the job is completed. This opportunity motivates drivers to work professionally and more responsibly. There is no fee that the platform takes from the tip amount, even though it's still transferred through platform. Tips are transferred in full amount to the driver.

A key aspect for ensuring successful functionality of the system is the management of locations and endpoints for items which do not have a consumer-identified delivery location. These may include items which are disposed of or are to be donated. In these situations, the consumer simply wants the items to be gone; they're usually not concerned with how and where they're disposed of Thus, automatic delivery location for these items is one of the key features of the platform, since it removes the need for the consumer to find a delivery location for their items, such that during the job creation process, the consumer does not need to worry about the nearest landfill location which matches his type of load. This process is automatically accomplished by the platform as described herein.

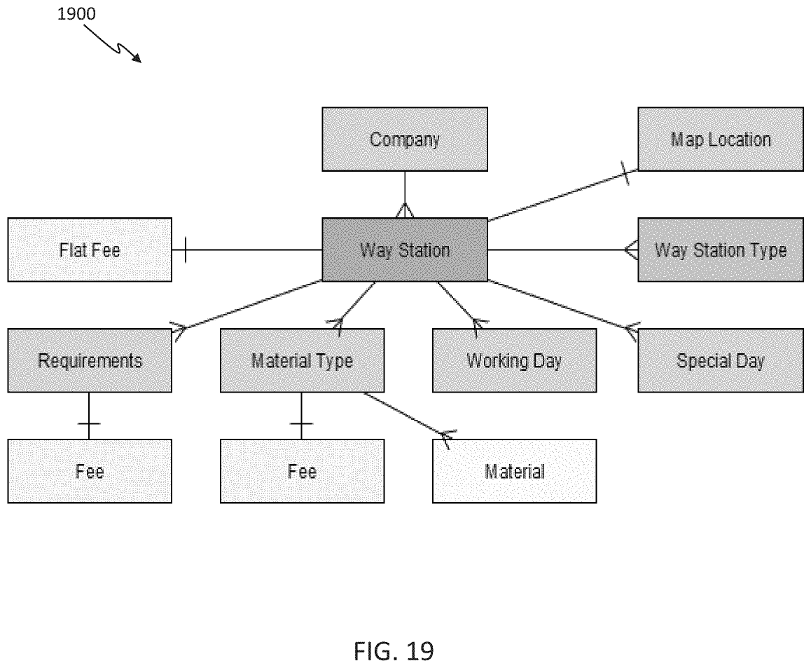

The system identifies the delivery location for items to be disposed of, recycled, or otherwise delivered to a place without the consumer's input as ‘way stations.’ Way stations may include dumps, recycling centers, landfills, donation centers, or other places where items can be disposed of The platform has a way station database with a list of way stations along with relevant characteristics and/or criteria of those way stations. Way stations are added and defined by the platform's administration. The platform may identify a way station as a location on the map with certain specific parameters. Diagram 1900 of FIG. 19 provides a graphical diagram of the way station architecture and database. Way stations are generally owned by certain companies which are in the business of accepting refuse, and therefore, they could have different parameters and classification from one another, such as requirements for accepting items, material types accepted, locations, working schedules, or others. For example, as illustrated in FIG. 19, a way station may be categorized by a company that owns it, a location, a type of way station, the fee at the weigh station charges, requirements of the way station, material types that the way station accepts, working days at the way station, or other special days. Further, the requirements and material type make further be identified by certain parameters, such as the specific fees charged or the materials accepted.

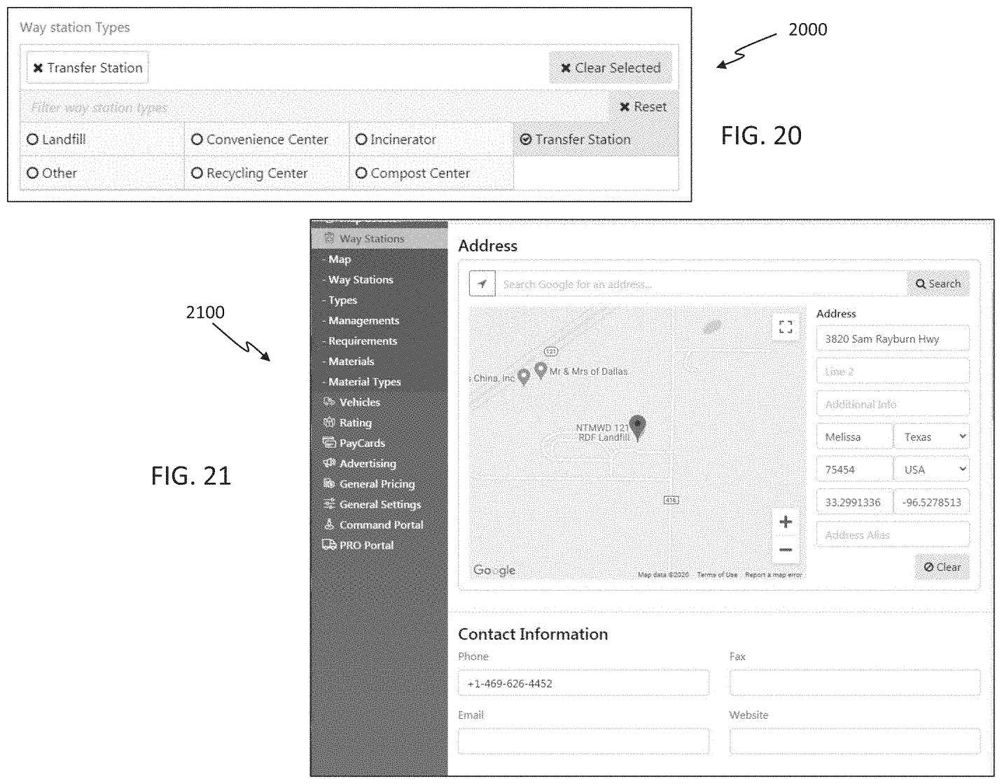

Classifying the way stations is an important aspect of the way station database. There are several different types of way stations in the platform, which the computer process is specific to identifying, classifying and segmenting any and all goods to the appropriate processing center. For example, the way station may be classified by type, e.g., transfer station, compost center, recycling center, incinerator, convenience center, landfill, or other. Each of these types may be given a description of the entity operating the way station, e.g., municipality or private, and be assigned other criteria. This criterion may include hours of operation, costs for disposal of specific items, payment methods, and others. The platform may diversify the types of way stations as shown by diagram 2000 in FIG. 20.

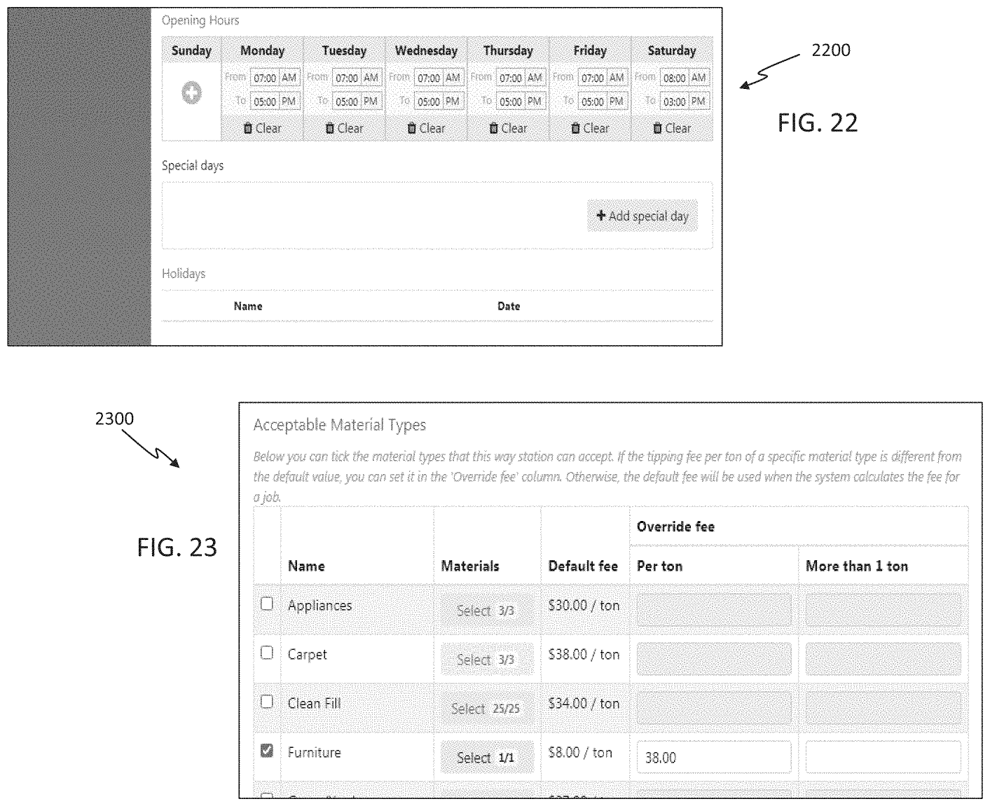

The location of a way station is also an important attribute to the platform, such that efficient delivery and disposal of the items can be achieved. Location parameters, including latitude and longitude, of the way station can be used to indicate the exact point on the map, which is later used in the matching algorithm calculation. Diagram 2100 in FIG. 21 provides an illustration of the interface of the platform for identifying a way station on a map. As well as location, another important parameter for matching a job to a way station is the working hours of the way station. During the initial way station setup within the platform, usual working hours are predefined. These can be overridden by the platform administration, including adding special days such as holidays. An example of the working hours interface of the platform is shown by diagram 2200 in FIG. 22.

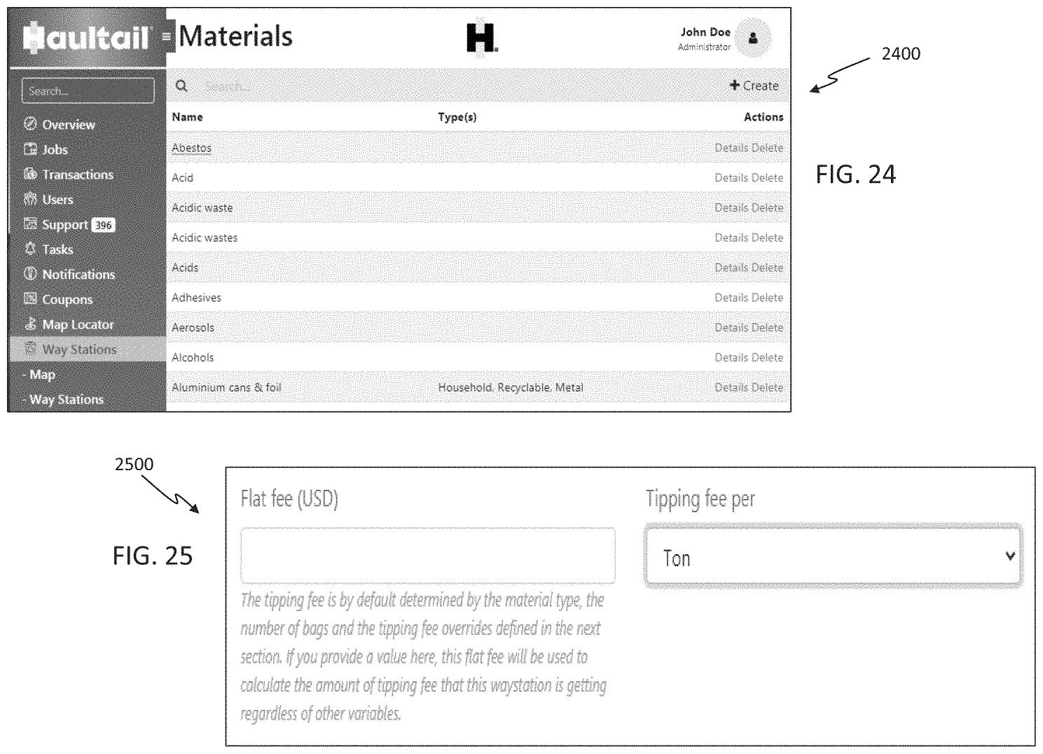

The materials which are accepted by the way station also need to be accounted for. Some way stations may accept all forms of refuse, whereas others may have restrictions on what is or is not accepted. The way station database of the platform contains different delivery materials, their types and defined fees for each of the types. These materials and types are managed by the platform's administration and used as acceptable way station items, which may have specific unique fee configuration. This is an important part of the platform, as these are one of the parameters used to identify the type of the way station which could accept items from the consumer as well as participating in the final price calculation algorithm. Diagram 2300 in FIG. 23 provides an exemplary interface of the acceptable materials type for a way station, and diagram 2400 in FIG. 24 provides an example of the interface for adding or removing a material to the way station database.

Some way stations may have flat fee requirements, where a truckload of refuse can be disposed of for a set, flat price. These flat fee requirements are reflected in the platform and can be an important part of the pricing calculation for the job, if defined. The tipping fee is by default determined by the material type, the number of bags and the tipping fee overrides. If a fee is defined, it will be used to calculate the amount of tipping fee that this way station is getting regardless of other variables. FIG. 25 has a diagram 2500 which is an example of the flat fee for tipping used by the platform. As shown, there may be three different amount measurements for the tipping fee, which could be set at per ton, per cubic yard, or per item. Other measurements for the tipping fee may include per truck load.

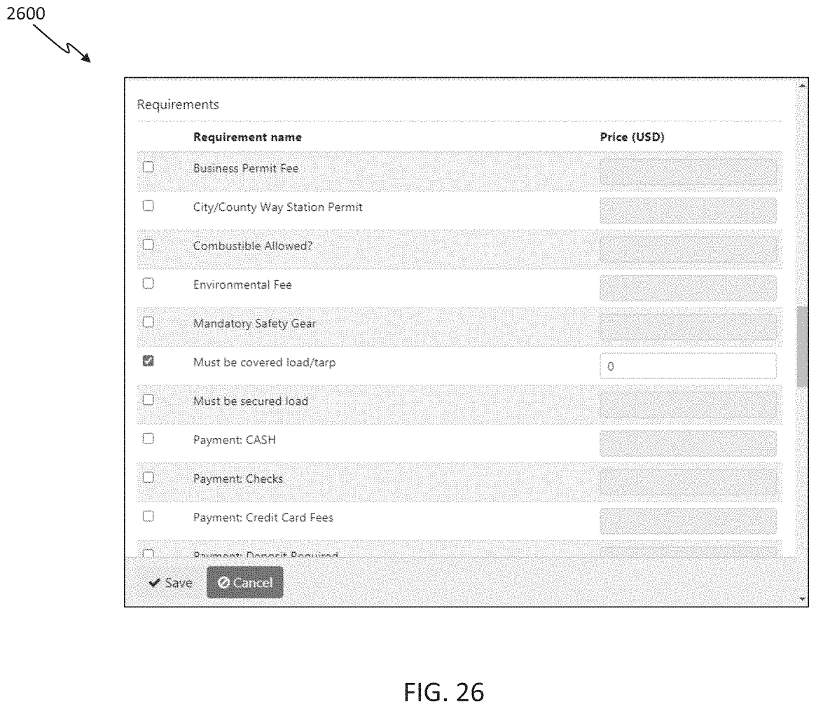

Another aspect of the platform, which interfaces with the way station database, is the requirement to define certain specific elements that a driver should have or have to follow to approach a way station. For example, requirements may include the need for a permit, the payment of a fee, the use of specific safety gear, or others. Some of these requirements may or may not have a specific monetary fee assigned, whereas others may have logistical requirements, such as the need to cover or tarp a load. Requirements also participate in the final service price calculation. An example of the requirements aspect of the platform is shown by diagram 2600 in FIG. 26.

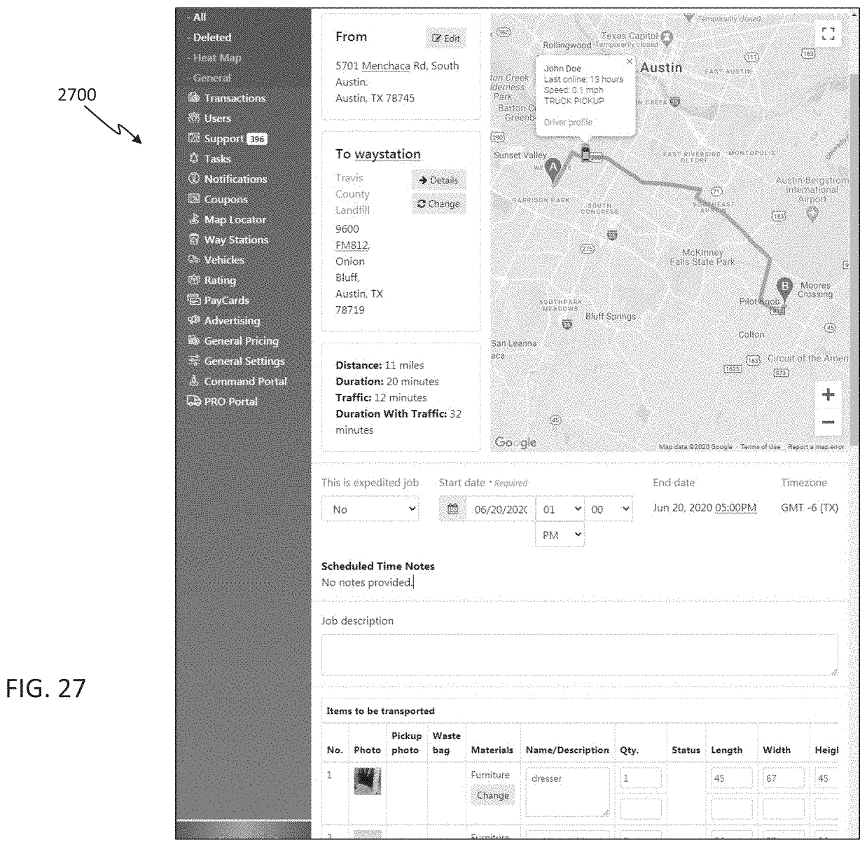

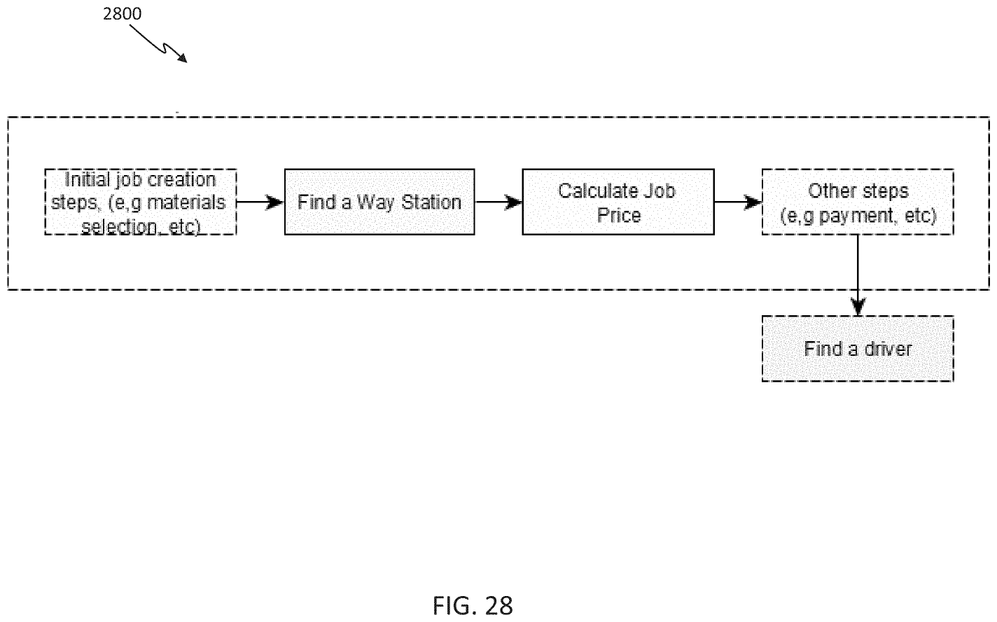

To ensure that the delivery of items to a way station is efficient, the way station database may interface with a matching process to the job, the consumer, and/or the driver. The platform may be able to match the closest driver along with the closest way station according to all job parameters and calculating the final price in real time or near-real time. This is a key feature of the database, since it allows for a dynamic and adaptable delivery location (to a way station) based on dynamic parameters, such as the pick-up location, the type of items to be disposed of, and the driver's location. Generally, the platform will default to the shortest route for having the driver dispose of the items. FIG. 27 is an image 2700 of the routing process to a way station. Way station matching may be a part of the job creation process. Its algorithm, taking in account material types, is depicted in diagram 2800 in FIG. 28, and a code representation of the process for way station matching is shown below:

public static function matchWaystation($validated)
{

| | |
|---|---|
| $state | = $validated[ ′stateID′ ]; |

// onLy get Waystation where′startpoint′and′startpointZipcode′is set.

| | |
|---|---|
| $startpoint | = $validated[ ′startpoint′ ] ?? null; |
| $startpointZipcode | = $validated[ ′startpointZipcode′ ] ?? null; |

```
  $materialTypeIds = [ ];
  foreach ($validated[ ′jobContentItems′ ] as $item) {
    if ( !empty($item [ ′wasteMaterials′ ])) $materialTypeIds = array_merge($materialTypeIds,
$item[ ′wasteMaterials′ ]);
  }
  $waystation = self: :getBestWaystationMatch($startpoint, $startpointZipcode, $state,
$materialTypeIds);
  return [
    ′waystation′=> $waystation,
  ];
}
```

```
private static function getBestWaystationMatch($startpoint, $startpointzipcode, int $stateId,
array $materialTypeIds)
{
  // Run search for nearby waystations:
  $allAccesibleWaystations = State: :findOrFail($stateID)->waystations( )
    ->selectDistance($startpoint)
    ->isActive( )
    ->where(function ($query) use ($materialTypeIds) {
      // check if aLL materiaLs are acceptable on a waystation
      if ( !empty($materialTypeIds)) {
        foreach ($materialTypeIds as $materialTypeId) {
          $query->whereHas( ′materialTypes′, function ($query) use ($materialTypeId)
{
            $query->where( ′material_types.id′, $materialTypeId);
          });
        }
      }
    })
    ->having( ′distance′, ′<=′, 10000)
    ->orderBy( ′distance′, ′asc′ )
    ->limit(5)
    ->get( );
  // CaLcuLate distance for aLL fetched Waystations:
  $waystations = collect($allAccesibleWaystations)->map(function ($waystation) use
($startpoint) {
    $waystation->distance = Map: :directDistance($startpoint, $waystation->
address->coordinates( ));
    return $waystation;
  })->filter(function ($waystation) {
    // Return onLy results with distance
    return $waystation->distance != null;
  });
  // SeLect the first result:
  return $waystations->sortBy( ′distance′ )->values( )->first( );
}
```

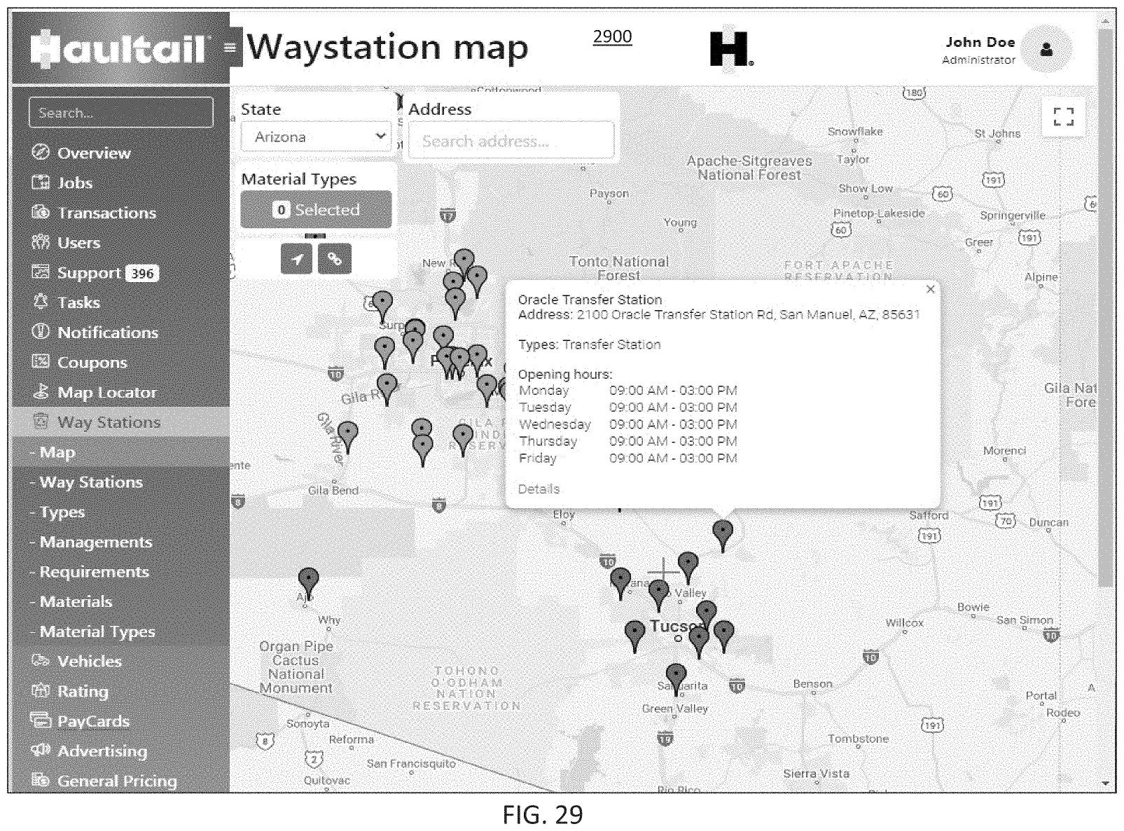

The platform has a management interface which provides a management overview and associated tools for handling various processes of the system. FIG. 29 is an image 2900 of one example of the management interface, which shows way station maps along with associated data for a certain operational area. As shown, the administrator of the platform can have an overview on a map which can be used to identify and manage way station details, their types, companies they are assigned to, requirements, materials and their types and, of course, pricing and fees.

With regards to pricing and fees, the platform may have a pricing management and configuration module which automatically prices jobs for consumers. In one example, there may be 6 tiers available for each operation area. Each tier may be subject to certain parameters, from which total price will be calculated for a standard driver. In one example, these parameters may include:
Base Price
Mile Price
Time Price
Expedited hour limitation
Insurance flat fee
Driver flat fee percentage
Repeat discount percentage
Minimum miles
Minimum time
Service charge
There may be other and/or additional settings for other drivers, such as lead or Pro drivers. The platform calculates the final price for the delivery automatically, based on the parameters above, as well as other aspects, as needed, e.g. coupons or promotions.

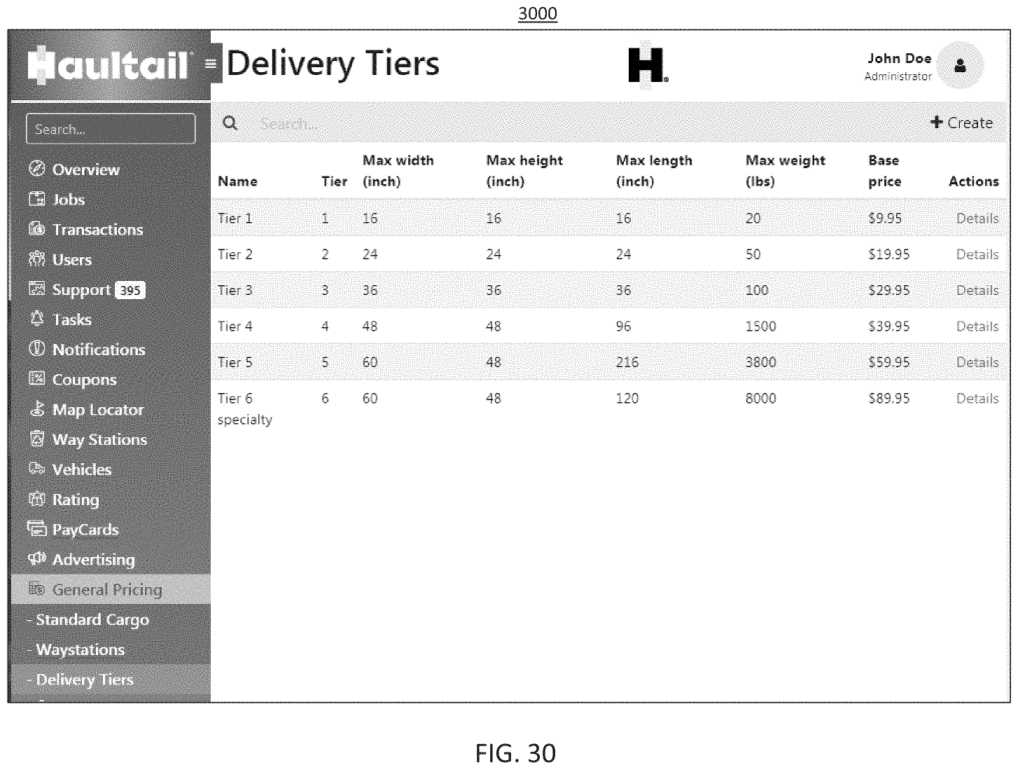

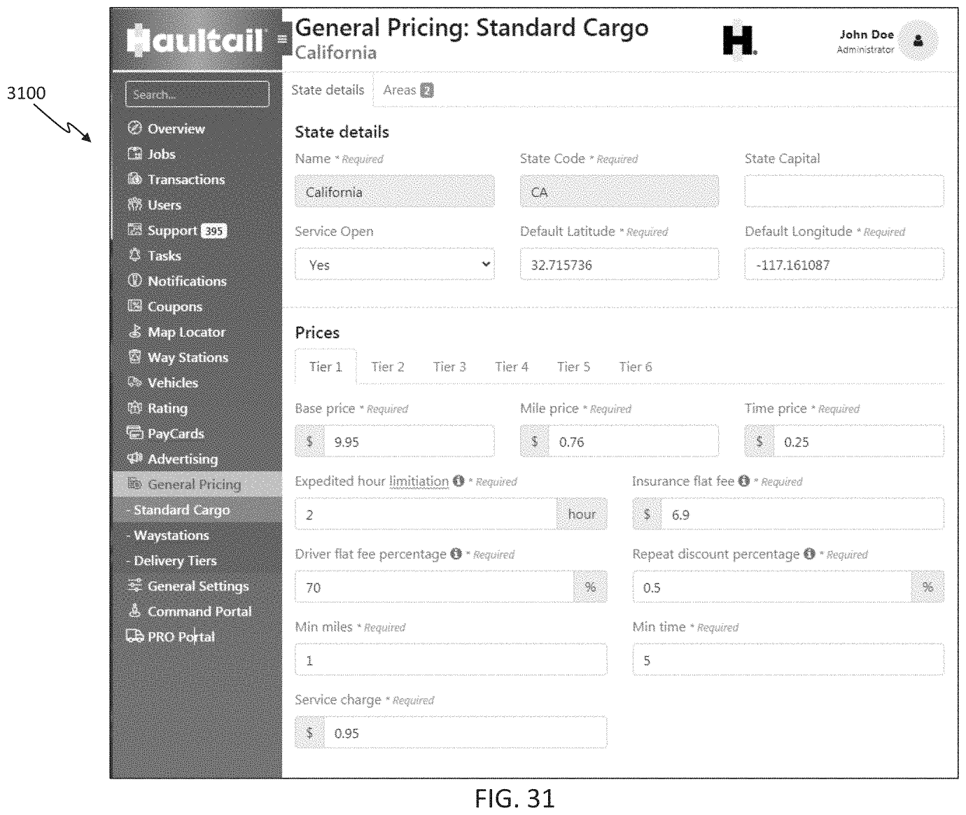

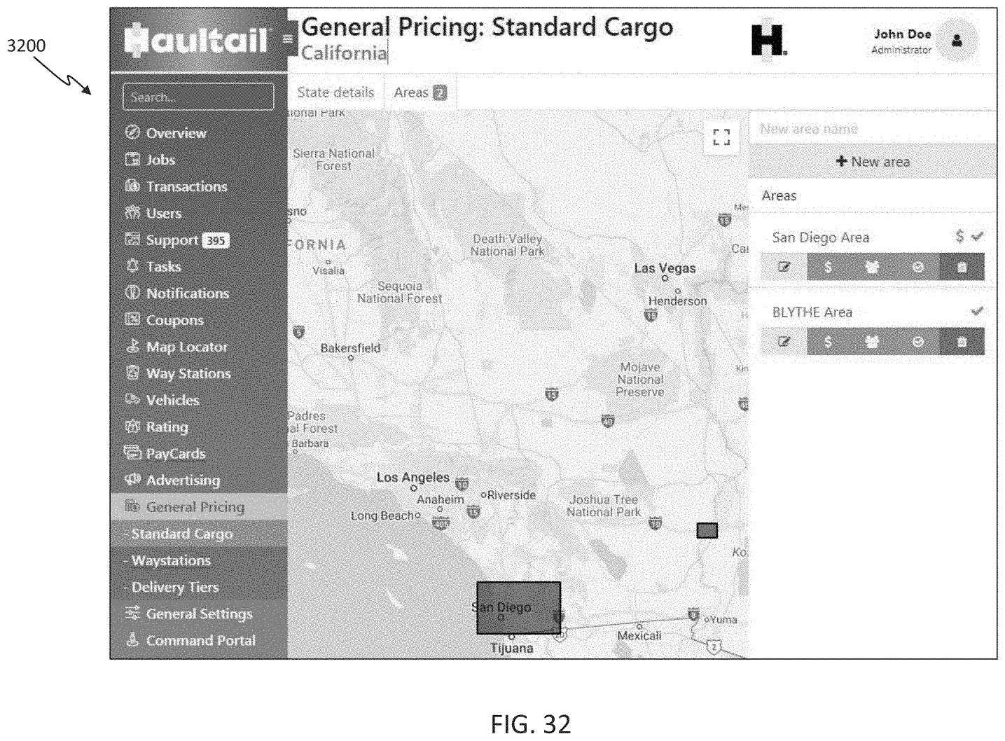

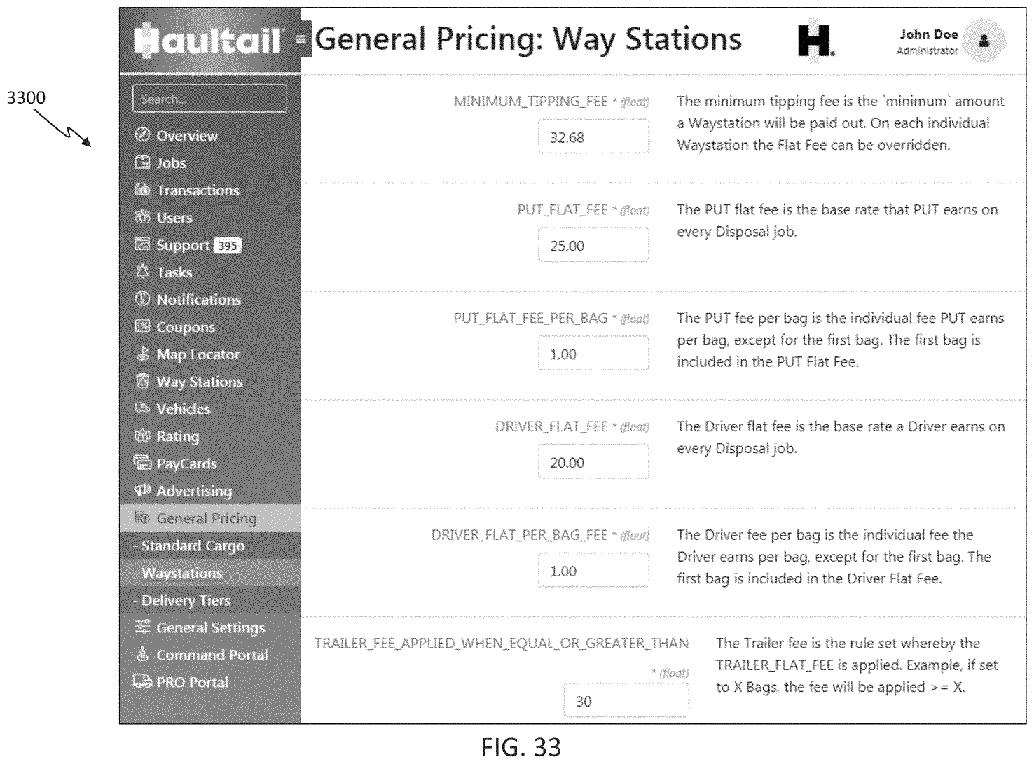

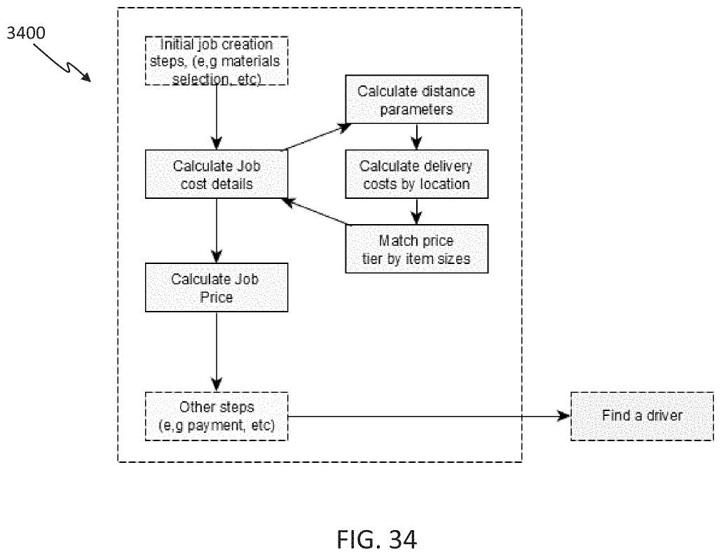

FIG. 30 is diagram 3000 showing an example of an interface of the platform showing the general delivery tiers which are applied by default to the operating areas. Diagram 3100 in FIG. 31 provides an example of how the tiers of FIG. 30 which can be redefined by administration of the platform as needed. FIG. 32 is diagram 3200 which provides an example of the interface of the platform which shows pricing areas. Pricing areas can be defined along with general state pricing. Administrators could override state prices for certain defined areas. The diagram 3300 in FIG. 33 illustrates default configuration pricing for the way stations. These values can be overridden from the respective areas of the administration tool within a specific way station. FIG. 34 illustrates a diagram 3400 showing one example of how the platform calculates pricing. As shown, the platform may calculate the final price automatically including parameters described relative to FIGS. 30-33. It may also calculate and apply delivery distance measurements of the job request as well as time.

Exemplary code snippets for the various processes described herein is shown below:

Calculating additional distance parameters according to locations, driving duration and traffic conditions:

```
public function setDistances($distanceMatrix = null) {
  if ( !$distanceMatrix) {
    $distanceMatrix = Map: :distanceMatrix($this->startpointAddress->coordinates( ),
$this->endpointAddress->coordinates( ), strtotime($this->scheduledTime));
  }
  $this->distance = ceil($distanceMatrix->distance);
  $this->duration = ( (int)($distanceMatrix->distance / 60) + 1) * 60;
  $this->durationInTraffic = ( (int)($distanceMatrix->durationInTraffic / 60) + 1) * 60;
  // max speed in city is 30 miLes/hour
  if ($this->distance > 15) {
    $durationInCity = ceil(15 / 30 * 60) * 60;
    $theRestDistanceDuration = ( ($this->distance − 15) / $this->distance) *
$this->durationInTraffic;
    $commonDuration = $durationInCity + $theRestDistanceDuration;
    if ($commonDuration > $this->durationInTraffic) $this->durationInTraffic =
$commonDuration;
  } else {
    $durationInCity = ceil($this->distance / 30 * 60) * 60;
    if ($durationInCity > $this->durationInTraffic) $this->durationInTraffic =
$durationInCity;
  }
}
```

Calculating delivery costs by a location, where every Area of Operation has its own settings for the prices. The platform algorithm applies these settings for calculating preliminary job cost:

```
public function deliveryPricesByCoordinates( )
{
  $lat = $this->startpointAddress->latitude;
  $lng = $this->startpointAddress->longitude;
  $state = $this->startpointAddress->state;
  $state->load ([
    ′zones′=> function($query) use ($lat, $lng) {
      $query->has( ′deliveryPrices′ )
        ->where( ′startLat′, ′<′, $lat)
        ->where( ′endLat′, ′>′, $lat)
        ->where( ′startLng′, ′<′, $lng)
        ->where( ′endLng′, ′>′, $lng)
        ->where( ′isActive′, 1)
        ->orderBy( ′priority′, ′desc′ );
    },
    ′zones.deliveryPrices′,
    ′zones.zoneLeads′,
  ]);
  $deliveryPrices = $state->deliveryPrices;
  $deliveryPriceZoneName = $state->name;
  if ($state->zones->count( )) {
    $zone = $states->zones->first( );
    if ( !empty($zone->deliveryPrices)) {
      $deliveryPrices = $zone->deliveryPrices;
      $deliveryPriceZoneName = $state->name. ′, ′.$zone->name;
    }
    $this->stateZoneId = $zone->id;
    $deliveryLocationZoneName = $state->name. ′, ′.$zone->name;
  }
  // try to choose tier depend on item sizes
  if ( !$this->tierId) $this->setJobTierByItemsSize( );
  $deliveryPrices = $deliveryPrices->where( ′vehicleTierId′, $this->tierId)->first( );
  if ($deliveryPrices) {
    $deliveryPrices->deliveryPriceZoneName = $deliveryPriceZoneName;
    $deliveryPrices->deliveryLocationZoneName = $deliveryLocationZoneName ?? null;
  }
  return $deliveryPrices;
}
```

Determining job tier by item sizes, where each job tier is matched along with the consumer's item sizes.

```
public function setJobTierByItemsSize( )
{
  if ( !$this->items->count( )) $this->load( ′items′ );
  // onLy smaLL item jobs can be with tiers 1
  if (in_array($this->jobSubTypeId, [6, 7])) {
    // then remain tier 1
    $quantity = 0;
    $weight = 0;
    if ($this->items->count( )) {
      foreach($this->items as $item) {
        $quantity += $item->quantity;
        $weight += $item->weight * $item->quantity;
      }
    }
    if ($quantity <= 10 && $weight <= 150) $this->tierId = 1;
    else $this->tierId = 2;
  } else {
    if ($this->items->count( )) {
      $maxSizes = new \stdClass( );
      $maxSizes->maxHeight = 0;
      $maxSizes->maxWidth = 0;
      $maxSizes->maxLength = 0;
      $maxSizes->maxWeight = 0;
      foreach ($this->items as $item) {
        if ($item->height > $maxSizes->maxHeight) $maxSizes->maxHeight =
$item->height;
        if ($item->width > $maxSizes->maxWidth) $maxSizes->maxWidth = $item->width;
        if ($item->length > $maxsizes->maxLength) $maxSizes->maxLength =
$item- >length;
        $maxSizes->maxWeight += $item->weight * $item->quantity;
      }
      $deliveryTier = DeliveryTier: :where( ′maxWidth′, ′>=′, $maxSizes->maxHeight)
        ->where( ′maxWidth′, ′>=′, $maxSizes->maxWidth)
        ->where( ′maxLength′, ′>=′, $maxSizes->maxLength)
        ->where( ′maxWeight′, ′>=′, $maxSizes->maxWeight)
        ->first( );
    }
    $this->tierId = $deliveryTier->id ?? 4;
    if ($this->tierId == 1) $this->tierId = 2;
  }
  if ($this->isDisposal( ) && $this->tierId < 4) $this->tierId = 4;
}
```

One key aspect of the platform is the ability to automatically calculate a delivery distance and determine a pricing calculation based on that distance. The system may use an algorithm which receives geolocation data from the way station database and from the consumer's initial input of information, and then calculates a distance between the two points. The platform may also calculate the time it should take for delivery, along with other relevant information, such as traffic, detours, etc. An example of the code containing the algorithm for pricing calculation is shown herein:

```
public function calculateJobCostDetails( )
{
  // caLcuLation detaiLs for portaL
  $calculationDetails = [ ];
  $deliveryPrices = $this ->deliveryPricesByCoordinates( );
  $jobTotal = 0;
  if ( !empty($deliveryprices ->basePrice)) {
    $jobTotal = $deliveryPrices ->basePrice;
    $calculationDetails[ ] = [
      ′name′=>′Base price′,
      ′amount′=> (float)number_format($deliveryPrices ->basePrice, 2, ′. ′, ′′ ),
      ′stateZoneName′=> $deliveryPrices ->deliveryPriceZoneName,
      ′loactionStateZoneName′=> $deliveryPrices->deliveryLocationZoneName,
    ];
    if ($deliveryPrices ->milePrice) {
      if ( !empty($deliveryPrices->minMiles) && $this->distance < $deliveryPrices->minMiles)
        $this ->distance = $deliveryPrices ->minMiles;
      if ( !empty($deliveryPrices->minTime) && $this ->duration < $deliveryPrices->minTime * 60)
        $this ->duration = $deliveryPrices->minTime * 60;
      if ( !empty($deliveryPrices->minTime) && $this ->durationInTraffic < $deliveryPrices->minTime *
60)
        $this->durationInTraffic = $deliveryPrices->minTime * 60;
      $jobTotal += $deliveryPrices->milePrice * $this->distance;
      $calculationDetails[ ] = [
        ′name′=>′Price of distance′,
        ′amount′=> (float)number_format(($deliveryPrices->milePrice * $this->distance), 2, ′. ′,
′′ ),
      ];
      // price per minute
      if ($this->durationInTraffic) {
        // convert to minutes
        $durationIntraffic = $this->durationInTraffic / 60;
        if ($this->durationInTraffic % 60 > 0) $durationInTraffic += 1;
        $jobTotal += $deliveryPrices->timePrice * $durationInTraffic;
        $calculationDetails[ ] = [
          ′name′=>′Price of time spent′,
          ′amount′=> (float)number_format(($deliveryPrices->timePrice * $durationInTraffic), 2,
′. ′, ′′ ),
        ];
      }
      $jobTotal += $deliveryPrices->serviceCharge;
      $calculationDetails[ ] = [
        ′name′=>′Service charge′,
        ′amount′=> (float)number_format($deliveryPrices->serviceCharge, 2, ′. ′, ′′ ),
      ];
    } else {
      \Illuminate\Support\Facades\Log: :debug(
      ″ \n\n\n ″.
      ′calculateJobCost: Tier -′.$deliveryPrices->vehicleTierId.
      ′, state -′.$this ->startpointAddress->state->id.
      ″\n\n\n ″ );
    }
  }
  if ($this->isDisposal( )) {
    $waystation = $this->jobbable->waystation ?? null;
    if ($waystation) {
      // get weight materiaLs from aLL bags
      $materialsArray = [ ];
      foreach ($this->items as $item) {
        foreach ($item->wasteMaterials as $wasteMaterial) {
          if ( !isset($materialsArray[ $wasteMaterial->id])) {
            $materialsArray[ $wasteMaterial->id] = [ ];
            $materialsArray[ $wasteMaterial->id][ ′weight′ ] = 0;
            $material = $waystation->materialTypes->where( ′id′, $wasteMaterial->id)->first( );
            $materialsArray[ $wasteMaterial->id][ ′feePerTon′ ] = $material->pivot->feePerTon ?? 0;
            $materialsArray[ $wasteMaterial->id][ ′feePerCubicYard′ ] = $material->
pivot->feePerCubicYard ?? 0;
            $materialsArray[ $wasteMaterial->id][ ′feePerCubicYard′ ] = $material->
pivot->feePerCubicYard ?? 0;
            $materialsArray[ $wasteMaterial->id][ ′feePerItem′ ] = $material->pivot->feePerItem ?? 0;
            $materialsArray[ $wasteMaterial->id][ ′name′ ] = $material->name ??′′;
            // get defauLt vaLue for this materiaL
            if ($waystation->tippingFeePer == 1 && !$materialsArray[ $wasteMaterial->id]
[ ′feePerTon′ ]) {
              $materialType = MaterialType: :where( ′id′, $wasteMAterial->id)->first( );
              if ($materialType) $materialsArray[ $wasteMaterial->id][ ′feePerTon′ ] =
$materialType- >defaultFeePerTon;
            }
            if ($waystation->tipping FeePer == 2 && !$materialsArray[ $wasteMaterial->id]
[ ′feePerCubicYard′ ]) {
              $materialType = MaterialType: :where( ′id′, $wasteMaterial->id)-> first( );
              if ($materialType) $materialsArray[ $wasteMaterial->id][ ′feePerCubicYard′ ] =
$materialType->default FeePerCubicYard;
            }
            if ($waystation->tippingFeePer == 3 && !$materialsArray[ $wasteMaterial->id]
[ ′feePerItem′ ]) {
              $materialType = MaterialType: :where( ′id′, $wasteMaterial->id)->first( );
              if ($materialType) $materialsArray[ $wasteMAterial->id][ ′feePerItem′ ] =
$materialType->defaultFeePerItem;
            }
          }
          $materialsArray[ $wasteMaterial -> id][ ′weight′ ] += (float)$item ->weight *
(int)$item->quantity;
        }
      }
      $waystationTippingFee = 0;
      foreach ($materialsArray as $material) {
        // ton
        if ($waystation->tippingFeePer == 1) {
          $weight = (int)($material[ ′weight′ ] / 2000) + 1; // Lbs per us tonn
          $waystationTippingFee += $weight * $material[ ′feePerTon′ ];
          $calculationDetails[ ] = [
            ′name′=>′Waystation fee ( ′.$material[ ′name′ ]. ′ ) ( ′.$weight. ′ *
′.$material[ ′feePerTon′ ]. ′ )′,
            ′amount′=> (float)number_format(($weight * $material[ ′feePerTon′ ]), 2, ′. ′, ′′ ),
          ];
        }
        // Cubic Yard
        elseif ($waystation->tippingFeePer == 2) {
          $volume = (int)($material[ ′weight′ ] / 2000 * 1.3) + 1; // 1 tonn ~= 1, 3 cub.yard
          $waystattionTippingFee += $volume * $material[ ′feePerCubicYard′ ];
          $calculationDetails[ ] = [
            ′name′=>′Waystation fee ( ′. $material[ ′name′ ]. ′ ) ( ′. $volume . ′ *
′.$material[ ′feePerCubicYard′ ]. ′ )′,
            ′amount′=> (float)number_format(($volume * $material[ ′feePerCubicYard′ ]), 2, ′. ′, ′′ ),
          ];
        }
      }
      if ($waystation->flatFee) {
        $waystationTippingFee += $waystattion->flatFee;
        $calculationDetails[ ] = [
          ′name′=>′Waystation flat fee′,
          ′amount′=> (float)number_format($waystation ->flatFee, 2, ′. ′, ′′ ),
        ];
      }
      $materialsArray[ ′totalWaystationTippingFee′ ] = $waystationTippingFee;
      $minimumTippingFee = DisposalCalculation: :where( ′key′, ′MINIMUM_TIPPING_FEE′ )->
first( )->value ?? 0;
      if ($minimumTippingFee > $waystattionTippingFee) {
        $waystationTippingFee = $minimumTippingFee;
        $calculationDetails[ ] = [
          ′name′=>′Waystation minimum tipping fee′,
          ′amount′=> (float)number_format($minimumTippingFee, 2, ′. ′, ′′ ),
        ];
      }
      $jobTotal += $waystationTippingFee;
    }
  }
  return [
    ′jobTotal′=> $jobTotal,
    ′calculationDetails′=> $calculationDetails,
    ′waystationTippingFee′=> $waystationTippingFee ?? 0,
  ];
}
```

It should be noted that any process descriptions or blocks in flow charts should be understood as representing modules, segments, portions of code, functions, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of managing the collection and delivery of goods using mobile computing devices, the method comprising:
receiving, on a collection and delivery management system hosted on a centralized server, a request from a first user through an application on a first user computing device for a pick-up of at least one item from a first location;
identifying at least one second user of the collection and delivery management system capable of fulfilling the pick-up request;
transmitting details of the pick-up request to an application on a second user computing device of the identified at least one second user, wherein a visual map of the first location is displayed on a user interface of the second user computing device;
uploading information about the at least one item from the first user to the application of the second user computing device, wherein the information includes weight and/or dimensions of the at least one item; and
upon delivery of the at least one item from the first location to a second location by the at least one second user, validating delivery of the at least one item by the first user computing device through at least one code identifier, wherein the at least one code identifier is transmitted from the collection and delivery management system to the first user computing device.

2. The method of claim 1, wherein uploading information about the at least one item from the first user to the application of the second user computing device further comprises an image capture technique to identify the information about the at least one item from textual information on a receipt.

3. The method of claim 2, wherein the information about the at least one item is derived from at least one of: a product identifier, a UPC code, a bar code, a model number, or a serial number on the receipt.

4. The method of claim 2, wherein the first location is a store, and wherein the first location is identified based on a store identifier on the receipt.

5. The method of claim 1, wherein the second location further comprises a way station having facilities for disposal of the at least one item.

6. The method of claim 1, wherein the way station is selected from a database of possible way stations, wherein selection of the way station from the database of possible way stations is determined based on at least one material accepted by the way station, wherein the at least one item is within the at least one material accepted.

7. The method of claim 1, wherein the way station is selected from a database of possible way stations, wherein selection of the way station from the database of possible way stations is determined based on price of disposal of the at least one item at the way station.

8. A system of managing the collection and delivery of goods using mobile computing devices, the system comprising:
a collection and delivery management system hosted on a centralized server, wherein a request is received from a first user through an application on a first user computing device for a pick-up of at least one item from a first location;
at least one second user of the collection and delivery management system identified as being capable of fulfilling the pick-up request;
an application on a second user computing device, wherein a details of the pick-up request are transmitted to the application of the identified at least one second user, wherein a visual map of the first location is displayed on a user interface of the second user computing device, wherein information about the at least one item is uploaded from the first user to the application of the second user computing device, wherein the information includes weight and/or dimensions of the at least one item; and
at least one validation code identifier, wherein upon delivery of the at least one item from the first location to a second location by the at least one second user, delivery of the at least one item is validated by the first user computing device through the at least one code identifier, wherein the at least one code identifier is transmitted from the collection and delivery management system to the first user computing device.

9. The system of claim 8, wherein uploading information about the at least one item from the first user to the application of the second user computing device further comprises an image capture technique to identify the information about the at least one item from textual information on a receipt.

10. The system of claim 9, wherein the information about the at least one item is derived from at least one of: a product identifier, a UPC code, a bar code, a model number, or a serial number on the receipt.

11. The system of claim 9, wherein the first location is a store, and wherein the first location is identified based on a store identifier on the receipt.

12. The system of claim 8, wherein the second location further comprises a way station having facilities for disposal of the at least one item.

13. The system of claim 8, wherein the way station is selected from a database of possible way stations, wherein selection of the way station from the database of possible way stations is determined based on at least one material accepted by the way station, wherein the at least one item is within the at least one material accepted.

14. The system of claim 8, wherein the way station is selected from a database of possible way stations, wherein selection of the way station from the database of possible way stations is determined based on price of disposal of the at least one item at the way station.

15. A method of managing the collection and delivery of refuse goods using mobile computing devices, the method comprising:
receiving, on a collection and delivery management system hosted on a centralized server, a request from a first user through an application on a first user computing device for a pick-up of at least one refuse item from a first location;
identifying at least one second user of the collection and delivery management system capable of fulfilling the pick-up request, wherein the at least one second user is identified from a group of possible second users having a vehicle sized to carry the at least one refuse item;
transmitting details of the pick-up request to an application on a second user computing device of the identified at least one second user, wherein a visual map of the first location is displayed on a user interface of the second user computing device;
uploading information about the at least one refuse item from the first user to the application of the second user computing device, wherein the information includes at least one of: a weight of the at least one refuse item, a dimension of the at least one refuse item; a material of the at least one refuse item; a condition of the at least one refuse item; or a state of the at least one refuse item;
delivering, by the second user, the at least one refuse item to a second location, the second location being a way station, having facilities for disposal of the at least one refuse item, wherein the way station is selected from a database of possible way stations, wherein selection of the way station from the database of possible way stations is determined based on at least one material accepted by the way station, wherein the at least one refuse item is within the at least one material accepted; and
upon delivery of the at least one refuse item from the first location to the way station by the at least one second user, validating delivery of the at least one refuse item by the first user computing device through at least one code identifier, wherein the at least one code identifier is transmitted from the collection and delivery management system to the first user computing device.

16. The method of claim 15, wherein uploading information about the at least one refuse item from the first user to the application of the second user computing device further comprises uploading a digital image of the at least one refuse item by the first user.

17. The method of claim 15, wherein the way station is selected from a database of possible way stations, wherein selection of the way station from the database of possible way stations is determined based on price of disposal of the at least one refuse item at the way station.

18. The method of claim 15, wherein the way station is selected from a database of possible way stations, wherein selection of the way station from the database of possible way stations is determined based on a proximity of the way station to the first location.
